(19) United States
(12) Patent Application Publication
(10) Pub. No.: US 2004/0019499 A1
(43) Pub. Date: Jan. 29, 2004

(54) Information collecting apparatus, method, and program

(75) Inventor: Kimitaka Murashita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited of Kawasaki, Japan

(21) Appl. No.: 10/609,483

(22) Filed: Jul. 1, 2003

(30) Foreign Application Priority Data
Jul. 29, 2002 (JP) 2002-219103

(51) Int. Cl. G06F 17/60

(52) U.S. Cl. 705/1

(57) ABSTRACT

An event collecting destination site registering unit registers event collecting destination sites for detecting the presence or absence of an event which occurred on the network or in the real world. An information collecting destination site registering unit registers information collecting destination sites for collecting documents including data such as text, image, audio sound, and the like. An event detecting unit obtains information from the registered event collecting destination sites, discriminates an updating area of the obtained information, and detects the occurrence of the event. A keyword extracting unit extracts a keyword from the updating area of the information detected by the event detecting unit. An information searching unit searches the documents in the registered information collecting destination sites by using the keyword extracted by the keyword extracting unit. An information notifying unit notifies the user of a search result.

### BACKGROUND OF THE INVENTION

1. Field of the Invention

The invention relates to information collecting apparatus, method, and program for automatically collecting site information on the Internet and notifying the user of it and, more particularly, to information collecting apparatus, method, and program for automatically detecting update of information of a registered site, automatically collecting site information corresponding to update contents, and notifying the user of it.

1. Description of the Related Arts

Various information databases (sites) of enterprises, governments, autonomies, individuals, and the like are connected onto the Internet. The user of the Internet can obtain necessary and useful information from those information databases.

Various data such as text, audio sound, image, and the like and combined information of them (hereinafter, referred to as a “document”) have been registered on a network, for example, the Internet. There are a wide variety of documents such as advertisement, guide, manual, tool, and the like. There are documents which are unnecessary for the specific user, while there are documents which are very useful.

Among those documents, a new document particularly has much application. For example, a notification of an incidence of a new computer virus and information of its preventing method, its exterminating method, and the like are information valuable to the user connected to the Internet.

One of features of the network is instantaneousness. The information on the network can be obtained without a time lag. By obtaining the presence or absence of not only the computer virus but also a phenomenon (hereinafter, referred to as an “event”) which occurred on the Internet or in the real world from the document on the Internet, the information useful to the user can be rapidly obtained.

As an existing system for obtaining the document on the network, for example, there is a search engine. The search engine is a system for registering the document on the Internet and its keyword into a server and searching information by a keyword inputted by the user and is called an agent, an automatic collecting robot, or the like. The search engine scans the document stored in the server on the Internet and forms a document for displaying and a keyword database for searching.

As another existing system for obtaining the document on the network, there is an information update notifying system. The information update notifying system is a system for periodically monitoring a specific page designated by the user and, if there is a change, notifying the user of such a fact. The following methods for such a system have been proposed.

(1) Japanese Patent No. 3036445, “Update information monitoring system of homepage”

(2) No. 3062104, “WWW update notifying system”

(3) JP-A-10-198614, “Hypertext document update detecting method and client”

(4) JP-A-11-15716, “Document update notifying apparatus and document update notifying method”

(5) JP-A-11-25020, “Investigation proxy service apparatus for notifying the requester of the fact that there is a change in contents of WWW inserted program”

(6) JP-A-11-259354, “Update confirming method of information on the Internet”

(7) JP-A-2000-35913, “Hypertext document update detecting method and client”

(8) JP-A-2000-276394, “Web page information relaying system and Web page information relaying method”

(9) JP-A-2000-357122, “Web page update notifying method, recording medium, and Web page update notifying system”

(10) JP-A-2001-256100, “World Wide Web browser apparatus and update notifying method of world wide Web”

(11) JP-A-2002-73455, “Web page update notifying method, client service server, and program storing medium”

All of the above methods are techniques such that when a WWW site on the Internet is updated, the user is notified of the fact that it has been updated. The user can recognize the update of the information without setting a keyword.

However, the conventional systems and methods for obtaining the document on the network as mentioned above have problems. The problems of those prior arts will be described hereinbelow.

(Search Engine)

The search engine previously obtains information from the site on the Internet and extracts information necessary for the user by using a keyword for searching. It is the first problem of the search engine that the user has to set the keyword.

In the search engine for searching a large number of documents on the Internet as targets, it is necessary to input a correct keyword in order to obtain specific information. However, it is difficult for the general user to properly set the “keyword” associated with “information which he wants”.

For example, if the user who is interested in child education searches sites by using “child care” as a keyword, 100 thousand or more sites are hit. Since it is impossible to access all search results, the user ordinarily has to narrow down and search them again by using another keyword.

However, if the user mistakes the setting of the keyword for narrowing the sites down, a problem such that if thousands to ten thousands of search results are left, the sites cannot be narrowed down, or contrarily, if they are excessively narrowed down, target information cannot be searched, or the like occurs. As mentioned above, it is difficult to set the keyword for obtaining the target information, and the general user cannot easily do it.

The second problem of the search engine is that the user has to preliminarily know information regarding the information which the user wants. For example, it is now assumed that a certain manufacturer A company released a new product “XXX”. When the user wants information regarding “XXX” of A company, if the user knows the fact that “A company released XXX”, he can search by the search engine by using “XXX” as a keyword.

However, if the user knows only the fact that “A company released a new product” and not a product name, he cannot use “XXX” as a keyword. If he searches by using “new product of A company”, there is a possibility that, instead of “XXX”, a new release or the like of a product older than “XXX” (“new product” at the time when its release is announced) is hit.

Further, if the user does not even know that A company released a new product, he cannot obtain such information in spite of the fact that he is interested in the new product of A company. Therefore, the user needs to access periodically a homepage of A company and discriminate whether the new product has been released or not. As mentioned above, in order to obtain the target information, the user needs to preliminarily know facts about the target information. He cannot obtain information regarding what he does not know.

(Update Detection of WWW Page)

According to the update notifying technique of WWW, the system discriminates the presence or absence of the information updating in place of the user's periodical access. Problems of the existing WWW page updating method will be described hereinbelow.

(1) Japanese Patent No. 3036445, “Update information monitoring system of homepage”

In the above system, whether the document has been updated or not is discriminated on the basis of a checksum, a file size, header information, or the like of the WWW page. In the system, only the fact that there is a change can be recognized. The user needs to access and check what kind of change has been made.

(2) No. 3062104, “WWW update notifying system”

In the above system, when there is a change in a file of a WWW server, a detecting server for detecting the update of the file notifies the user corresponding to the file of the change. In a manner similar to the system of (1) mentioned above, also in the system, only the fact that there is a change can be recognized. The user needs to access and check what kind of change has been made.

(3) JP-A-10-198614, “Hypertext document update detecting method and client”

According to this method, the client side detects the update of the file of the WWW server by using a CRC. In a manner similar to the system of (1) mentioned above, such a system can also recognize only the fact that there is a change. The user needs to access and check what kind of change has been made.

(4) JP-A-11-15716, “Document update notifying apparatus and document update notifying method”

According to the above apparatus and method, a mediating apparatus for mediating a document detects the presence or absence of the update of the document and, if the presence is detected, the user is notified of such a fact. In this case, a portion which has been changed is emphasis-displayed, so that the user who requested the document can easily recognize it. According to the apparatus and method, when there is an obtaining request of the document, the presence or absence of the update is discriminated. Therefore, in the case of a document whose obtaining request is infrequent, whether the document has been updated or not is not known until the obtaining request is made. In a manner similar to (1) and (3) mentioned above, contents which are notified to the user relate only to the fact that the document has been updated. What kind of update has been made can be checked only when the user requests the document.

(5) JP-A-11-25020, “Investigation proxy service apparatus for notifying the requester of the fact that there is a change in contents of WWW inserted program”

The above apparatus is a system such that an investigation proxy service apparatus for investigating whether there is a change in contents of a WWW program or not in place of the user monitors a program requested by the user, and if there is a change, the user on a requesting source side is notified of such a fact. In a manner similar to the system of (1) mentioned above, also in the apparatus, only the fact that there is a change can be recognized. The user needs to access and check what kind of change has been made.

(6) JP-A-11-259354, “Update confirming method of information on the Internet”

According to the above method, a Web page confirming server for monitoring the update of a document is provided in a Web server and the Web page confirming server confirms a change in Web page on the basis of information registered in a servlet. In a manner similar to the system of (1) mentioned above, also in the method, only the fact that there is a change can be recognized. The user needs to access and check what kind of change has been made.

(7) JP-A-2000-35913, “Hypertext document update detecting method and client”

According to the above method, in a manner similar to the system of (1) mentioned above, a checksum of a document is compared and the presence or absence of the update of the document is discriminated. Also in the method, only the fact that there is a change can be recognized. The user needs to access and check what kind of change has been made.

(8) JP-A-2000-276394, “Web page information relaying system and Web page information relaying method”

According to the above method, a relaying system for relaying a Web page executes polling to the network and discriminates the presence or absence of update of information. If there is a change, the user is notified of the change contents. Unlike (1) to (7) mentioned above, in the method, since not only the presence of the change but also the change contents themselves are transmitted, the user can confirm the change contents by the notification from the relaying system without accessing.

According to the above method, only the change contents can be confirmed and the user needs to access another server with respect to other information, for example, information regarding the change contents stored in another server.

In the case of the document on the Internet, the change is frequently made. For example, in the news site or the like, there is a case where it is changed or deleted in one or two days. Even if the user receives a change notification, if there is a time lag until he accesses actually, there is a case where the document itself has already disappeared.

(9) JP-A-2000-357122, “Web page update notifying method, recording medium, and Web page update notifying system”

According to the above method, when the server for detecting the update of the information of WWW notifies the client of the information update, certification such that the notification is from a specific server is given by using a telephone number notifying function. This method is a high-security system because a connection from an unexpected server can be prevented.

However, in a manner similar to the system of (1) mentioned above, with respect to the update contents, unless the user accesses, he cannot recognize what kind of update has been made.

(10) JP-A-2001-256100, “World Wide Web browser apparatus and update notifying method of world Wide Web”

According to the above method, when the information of the WWW is updated, an image indicative of such a fact is displayed to a WWW browser, thereby notifying the user of the information update. In a manner similar to the system of (1) mentioned above, also in this method, only the fact that there is a change can be recognized. The user needs to access and check what kind of change has been made.

(11) JP-A-2002-73455, “Web page update notifying method, client service server, and program storing medium”

The above method relates to a system such that information of the Web page to which an updating notification has been requested by the user and an E-mail address of the user are preliminarily stored, and when the update is detected, such a fact is notified at the E-mail address. In a manner similar to the system of (1) mentioned above, also in this method, only the fact that there is a change can be recognized. The user needs to access and check what kind of change has been made.

As mentioned above, all of the conventional methods are techniques such that when the predetermined page is updated, the user is notified of the update. That is, according to the prior arts of (1) to (7) and (9) to (11), the user is merely notified of the fact that the update has been made and he has to access directly and check what kind of update has been made.

According to the prior art of (8), since the user is notified of the change contents, he can recognize the contents of the update without accessing the original information. Also, according to such a technique, however, the contents regarding only the updated document (WWW page) can be recognized.

For example, when new product information is registered in a homepage of an enterprise, by monitoring the page of the “new product information”, or the like, the user can recognize that the new product has been registered. However, in many cases, a detailed outline of the new product is registered in another location. When the user wants to know a reputation of the product, he has to access another server, for example, a technical system news site, a notice board site, or the like.

As mentioned above, in the prior art, to obtain more detailed information of the updated information, the user has to collect the information by himself on the basis of the notification such that the information has been “updated”.

### SUMMARY OF THE INVENTION

According to the invention, information collecting apparatus, method, and program which can collect information from a plurality of information providing destinations in place of the user without the user's setting a keyword or the like even in the case of unknown information are provided.

The invention provides an information collecting apparatus comprising: a network connecting unit which connects to a network; an event collecting destination site registering unit which registers event collecting destination sites for detecting the presence or absence of an event which occurred on the network or in the real world; an information collecting destination site registering unit which registers information collecting destination sites for collecting documents including data such as text, image, audio sound, and the like; an event detecting unit which obtains information from the registered event collecting destination sites and detects the presence or absence of the occurrence of the event from the presence or absence of an update of the obtained information; a keyword extracting unit which extracts one or more keywords from an updating area of the information detected by the event detecting unit; an information searching unit which searches the documents in the registered information collecting destination sites by using the keyword extracted by the keyword extracting unit; and an information notifying unit which notifies the user of a search result of the information searching unit.

Therefore, according to the invention, a specific server as an event collecting destination site, for example, a WWW site is monitored and when the event occurrence due to the update of the information is detected, the keyword to specify the event such as announcement of a new product, incidence of a new virus, or the like is extracted from update contents. The information is collected from the server registered as an information collecting destination site by using the keyword and the user is automatically notified of it. Thus, even in the case of the information which is unknown to the user, it can be automatically collected from a plurality of information providing destinations and provided to the user without making him to set a word for specifying the information such as a keyword or the like.

The event detecting unit accesses the event collecting destination site, downloads the document in the site, stores it as a reference, thereafter, downloads the document from the same event collecting destination site, and updates the reference by using the downloaded document.

The information searching unit accesses the information collecting destination site, downloads the document in the site, and searches a corresponding document portion in the downloaded document by using the keyword.

The information collecting apparatus of the invention further has a document storing unit for storing the document obtained from the information collecting destination site by the information searching unit. The document storing unit stores the searched document searched by the information searching unit by using the keyword used in the search as an index. Therefore, even if the information is deleted from the information collecting destination site, the user can access the necessary document anytime.

The information searching unit accesses periodically the information collecting destination site, downloads the documents in the site, stores them into the document storing unit, and thereafter, searches the documents stored in the document storing unit by using the keyword extracted by the keyword extracting unit at the time of the event detection.

Therefore, it is a fundamental manner of the invention to process in order such that the event occurrence is detected, the related information is searched, and the user is notified of it. In dependence on the kind of information, there is a case where the information is registered first into the information collecting destination site and the information is registered into the event collecting destination site later. In such a case, there is a case where when the event occurrence is detected from the event collecting destination site, the information has already been deleted from the information collecting destination site.

Therefore, the documents in the information collecting destination site are preliminarily stored into the document storing unit such as an external storing device or the like and by searching the stored documents, even the information registered in the information collecting destination site at timing before the event collecting destination site can be collected.

The information searching unit counts the number of searching times every document and deletes the documents in which the number of searching times is equal to or less than a predetermined threshold value from the document storing unit, thereby preventing a situation such that a new document cannot be stored. As timing for deleting the document, it is sufficient to delete it at the time of collection of the document or at every predetermined intervals.

If it is determined that an empty capacity of the document storing unit is insufficient, the information searching unit increases the threshold value which is used to discriminate the number of searching times and deletes the documents in which the number of searching times is equal to or less than the threshold value from the document storing unit. Thus, even if the documents in which the number of searching times is equal to or less than the predetermined threshold value are deleted, when the empty capacity in the external storing device is insufficient, the empty capacity can be increased by increasing the threshold value.

The event detecting unit detects a deleted abandoned area in addition to the updated area of the documents obtained from the event collecting destination site, searches the document storing unit by the keyword extracted from the abandoned area, and deletes the abandoned area from the stored documents.

Therefore, when the documents in the information collecting destination site which were searched and stored by the extracted keyword from the information update of the event collecting destination site become old and are deleted by the information update of the event collecting destination site, the keyword is extracted from the deleted abandoned area, and the stored documents are automatically deleted, thereby preventing a situation such that the stored documents are extremely increased and the site is filled with them.

The information searching unit searches the documents in the information collecting destination site which were periodically registered for a predetermined period of time by using the keyword extracted by the keyword extracting unit. Thus, the following functions are obtained. In the case where the event occurrence is detected from the event collecting destination site and the search for the document from the information collecting destination site is started, if the event collecting destination site and the information collecting destination site are different, there is a case where the timing for registering the information into the respective sites differs.

In this case, even if the event is detected and the information collection is started, the information is not registered in the information collecting destination site yet and the necessary information cannot be obtained. Therefore, by periodically repeating the information search for a predetermined period of time, omission of the information collection due to the time lag of the registering timing in the event collecting destination site and the information collecting destination site is prevented.

The information searching unit counts the number of searching times of the document using the keyword. If the number of searching times of the document at the time of the elapse of the predetermined period of time exceeds a predetermined threshold value, the information search of the document by the keyword is again continued for a predetermined period of time. If it is equal to or less than the threshold value, the information search by the keyword is stopped. Thus, the following functions are obtained.

If there is a time lag of the registering timing in the event collecting destination site and the information collecting destination site, there is a case where even if the information is periodically searched, the information cannot be obtained depending on a duration of the time lag. Therefore, the number of searching times is stored and if the number of searching times during a predetermined period of time is equal to or less than the predetermined threshold value, it is determined that novelty of the event has faded. The information collection is stopped.

The event collecting destination site registering unit obtains the event collecting destination site from an event collecting destination list server via the network and registers it. The information collecting destination site registering unit obtains the information collecting destination site from an information collecting destination list server via the network and registers it. In the invention, although the event collecting destination site and the information collecting destination site are preliminarily registered, it is also possible to obtain lists from dedicated servers and register them.

The event collecting destination site registering unit can obtain the event collecting destination site from another information collecting apparatus having substantially the same construction via the network and register it. Similarly, the information collecting destination site registering unit can obtain the information collecting destination site from the information collecting apparatus having substantially the same construction via the network and register it. Since the information collecting apparatus of the invention exists on the computer connected via the Internet, it is used as what is called “peer-to-peer” in a form such that the event collecting destination site and the information collecting destination site are used in common by the similar information collecting apparatuses.

The keyword extracting unit morpheme-analyzes the updating area of the information detected by the event detecting unit, divides it every part of speech, and thereafter, extracts only proper nouns. If the extracted nouns are different from the existing keywords registered in a keyword database, the extracted proper nouns are outputted as a keyword to the information searching unit. Thus, for example, a name of a new product, a name of a new computer virus, or the like is outputted as a keyword from the update information of the event collecting destination site, and the information collection by the document search from the information collecting destination site by the keyword can be made.

The keyword extracting unit additionally registers the proper nouns outputted as a keyword to the information searching unit into the keyword database. Thus, the keyword extracted in the event of this time is additionally registered into the keyword database, thereby preventing it from being extracted again as a keyword the next and subsequent times and avoiding the execution of the unnecessary search by the keyword after completion of the search.

If a plurality of keywords are extracted from the updating area of the information detected by the event detecting unit, the keyword extracting unit gives the priority to each keyword on the basis of the contents of the updating area and outputs the resultant keywords to the information searching unit.

In the case where only new information is added to the updating area of the event collecting destination site in which the event occurrence has been detected, the event detecting unit stores a history of the new information, and if the old information is deleted simultaneously with the addition of the new information into the updating area, the event detecting unit stores the history of the new information and that of the deleted information, thereby enabling the information notifying unit to notify the user of the stored histories.

By the storage of the updating histories, it is possible to notify the user of a list or the like of the updated information of the event collecting destination site. The user can recognize in which time sequence the information has been updated or deleted. For example, by merging the new information and the deleted information, for instance, a list of the products developed from the past to the present and a list of the products which are still being handled can be obtained.

In the case where only the new information is added to the updating area of the event collecting destination site in which the event occurrence has been detected, the event detecting unit stores the keyword extracted by the keyword extracting unit as a history of the new information, and if the old information is deleted simultaneously with the addition of the new information into the updating area, the event detecting unit stores the keyword extracted by the keyword extracting unit as a history of the new information and that of the deleted information, thereby enabling the information notifying unit to notify the user of the stored keywords.

Therefore, by extracting the keywords and notifying the user of their list as an updating history, the history can be more easily grasped than that in the case where only the histories of the updating area are arranged.

If the link with an external site exists in the new information added to the updating area, the event detecting unit downloads a document on the external link destination side, stores it into the document storing unit, and allows the document stored in the document storing unit to be linked with the history of the new information. Thus, even if the document is deleted from the information collecting destination server, the user can always access the document.

The invention provides an information collecting method for a network environment as a target. This information collecting method comprises:

an event collecting destination site registering step wherein event collecting destination sites for detecting the presence or absence of an event occurring on a network or in the real world are registered by an event collecting destination site registering unit;

an information collecting destination site registering step wherein information collecting destination sites for collecting documents including data such as text, image, audio sound, and the like are registered by an information collecting destination site registering unit;

an event detecting step wherein information is obtained from the registered event collecting destination sites and the presence or absence of event occurrence is detected by an event detecting unit on the basis of the presence or absence of update of the obtained information;

a keyword extracting step wherein a keyword is extracted by a keyword extracting unit from an updating area of the information detected in the event detecting step;

an information searching step wherein the documents in the registered information collecting destination sites are searched by an information searching unit by using the keyword extracted in the keyword extracting step; and

an information notifying step wherein the user is notified of a search result of the information searching step by an information notifying unit.

According to the invention, a program which is executed by a computer is provided. This program allows the computer to execute:

an event collecting destination site registering step wherein event collecting destination sites for detecting the presence or absence of an event occurring on a network or in the real world are registered;

an information collecting destination site registering step wherein information collecting destination sites for collecting a document including data such as text, image, audio sound, and the like are registered;

an event detecting step wherein information is obtained from the registered event collecting destination sites and the presence or absence of event occurrence is detected on the basis of the presence or absence of update of the obtained information;

a keyword extracting step wherein one or more keywords are extracted from an updating area of the information detected in the event detecting step;

an information searching step wherein the documents in the registered information collecting destination sites are searched by using the keyword extracted in the keyword extracting step; and

an information notifying step wherein the user is notified of a search result of the information searching step.

Details of the information collecting method and program according to the invention are fundamentally the same as those of the information collecting apparatus.

The above and other objects, features, and advantages of the present invention will become more apparent from the following detailed description with reference to the drawings

### BRIEF DESCRIPTION OF THE DRAWINGS

FIGS. 1A and 1B are functional block diagrams of an embodiment of an information collecting apparatus according to the invention;

FIG. 2 is an explanatory diagram of hardware resources of a computer to which the embodiment of FIGS. 1A and 1B is applied;

FIG. 3 is a flowchart of a fundamental processing procedure of an information collecting process according to the embodiment of FIGS. 1A and 1B;

FIGS. 4A and 4B are explanatory diagrams of new product release information obtained from an event collecting destination site;

FIGS. 5A and 5B are explanatory diagrams of another form of the new product release information obtained from the event collecting destination site;

FIG. 6 is a flowchart for another embodiment of the invention for storing documents searched by a keyword from information collecting destination sites;

FIGS. 7A and 7B are flowcharts for another embodiment of the invention in which after the documents collected from the information collecting destination sites were stored, the stored documents are searched by the keyword;

FIG. 8A is a flowchart for another embodiment of the invention for deleting the stored documents whose number of searching times is small;

FIG. 8B is a flowchart for another embodiment of the invention which is a sequel to FIG. 8A;

FIG. 9A is a flowchart for another embodiment of the invention in which a threshold value of the number of searching times by which the stored documents are deleted is increased, thereby assuring an enough empty capacity;

FIG. 9B is a flowchart for another embodiment of the invention which is a sequel to FIG. 9A;

FIG. 10A is a flowchart for another embodiment of the invention in which the keyword is extracted from an abandoned area deleted due to the information update of the event collecting destination site and the stored documents are deleted;

FIG. 10B is a flowchart for another embodiment of the invention which is a sequel to FIG. 10A;

FIGS. 11A and 11B are flowcharts for another embodiment of the invention in which the documents are periodically searched by the keyword until the elapse of a predetermined time from the detection of event occurrence;

FIG. 12A is a flowchart for another embodiment of the invention in which if the number of searching times is equal to or less than the threshold value during a predetermined period of time, it is regarded that novelty of the occurred event has been lost, and information collection is stopped;

FIG. 12B is a flowchart for another embodiment of the invention which is a sequel to FIG. 12A;

FIG. 13A is a flowchart for another embodiment of the invention for obtaining an event collecting destination site and an information collecting destination site from a list server;

FIG. 13B is a flowchart for another embodiment of the invention which is a sequel to FIG. 13A;

FIG. 14A is a flowchart for another embodiment of the invention for obtaining an event collecting destination site and an information collecting destination site from another information collecting apparatus;

FIG. 14B is a flowchart for another embodiment of the invention which is a sequel to FIG. 14A;

FIG. 15 is a flowchart for a keyword extracting process in the invention;

FIG. 16A is a flowchart for another embodiment of the invention for storing and using histories of new information and deleted information associated with the update of the event collecting destination site;

FIG. 16B is a flowchart for another embodiment of the invention which is a sequel to FIG. 16A;

FIG. 17A is a flowchart for another embodiment of the invention for storing and using the histories, as a keyword, of the new information and the deleted information associated with the update of the event collecting destination site;

FIG. 17B is a flowchart for another embodiment of the invention which is a sequel to FIG. 17A;

FIG. 18A is a flowchart for another embodiment of the invention for obtaining and storing a document from an external link destination in the new information associated with the update of the event collecting destination site; and

FIG. 18B is a flowchart for another embodiment of the invention which is a sequel to FIG. 18A.

### DETAILED DESCRIPTION OF THE PREFERRED EMBODIMENT

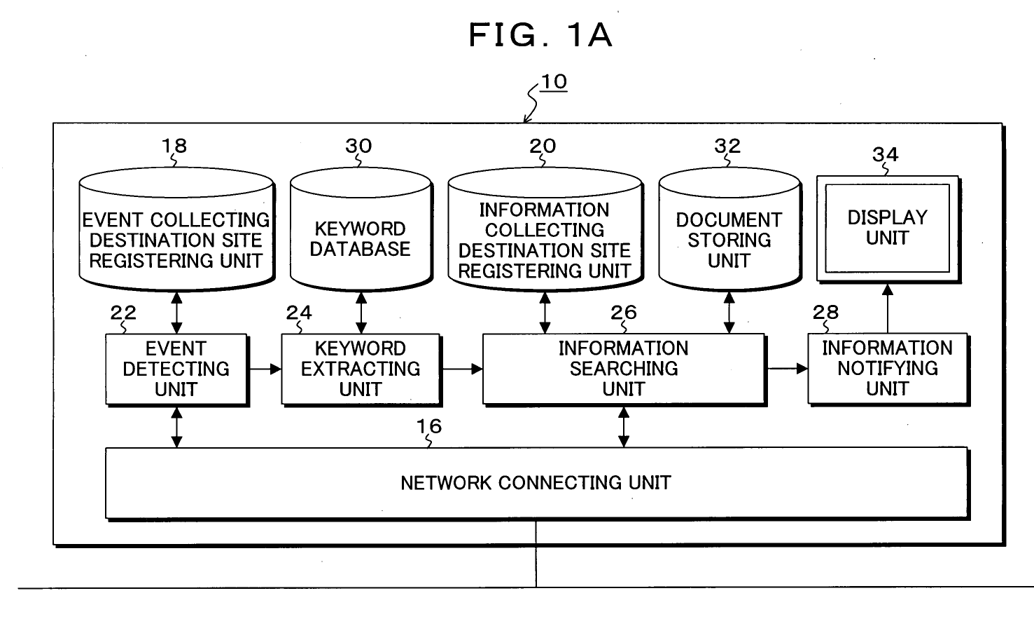

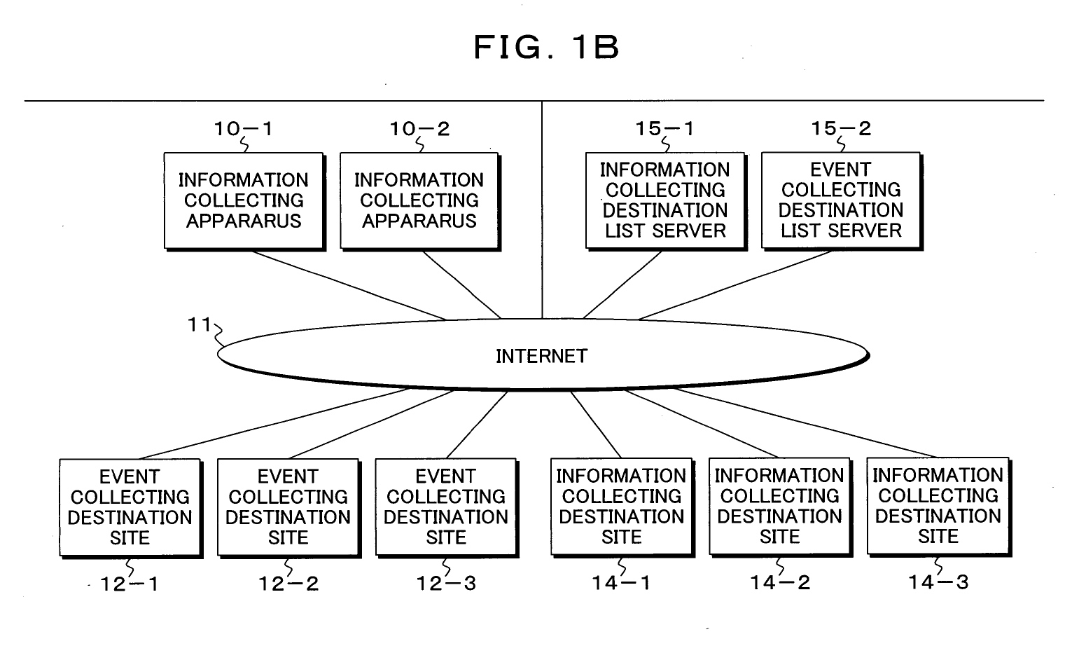

FIGS. 1A and 1B are functional block diagrams showing an embodiment of an information collecting apparatus according to the invention together with a network environment to which the invention is applied.

In FIGS. 1A and 1B, an information collecting apparatus 10 of the invention is realized by, for example, a personal computer which the user possesses. The information collecting apparatus is connected to a network such as an Internet 11 or the like, collects information necessary for the user from a site which functions as an information database established on the Internet, and uses it.

In the information collecting apparatus 10 of the invention, various servers connected to the Internet 11, for example, an ftp server, a WAIS server, an Archie server, a WWW server, and a NEWS server can be set to access targets. In the embodiment, the WWW server will be explained as an example.

In the invention, a phenomenon which occurred on the Internet or in the real world is defined as an “event” and by obtaining the presence or absence of the event from the site on the Internet, information useful to the user is collected. Therefore, in the invention, the server serving as a target for detection of the presence or absence of the occurrence of the event is called an event collecting destination site. In the example of FIGS. 1A and 1B, event collecting destination sites 12-1, 12-2, and 12-3 established by the WWW server connected to the Internet 11 are set to detecting destinations of the event occurrence.

In the invention, the WWW server for collecting specific information is defined as an information collecting destination site. In the example of FIGS. 1A and 1B, three information collecting destination sites 14-1, 14-2, and 14-3 which are realized by the WWW servers are shown as examples. The event collecting destination sites 12-1 to 12-3 and the information collecting destination sites 14-1 to 14-3 can be the different WWW servers or the same WWW server.

The information collecting apparatus 10 of the invention comprises: a network connecting unit 16; an event collecting destination site registering unit 18; an information collecting destination site registering unit 20; an event detecting unit 22; a keyword extracting unit 24; an information searching unit 26; an information notifying unit 28; a keyword database 30; a document storing unit 32 and a display unit 34.

The event collecting destination sites 12-1 to 12-3 for detecting the presence or absence of the occurrence of the event have been registered in the event collecting destination site registering unit 18. Specifically speaking, URLs serving as addresses of the event collecting destination sites 12-1 to 12-3 have been registered. As event collecting destination sites, arbitrary sites which the user needs the information collection are searched or collected and preliminarily registered.

The information collecting destination site registering unit 20 preliminarily registers the information collecting destination sites 14-1 to 14-3 for collecting information including data such as text, image, audio sound, and the like. The information including the text, image, audio sound, and the like on the Internet which is collected by the information collecting apparatus 10 of the invention is defined as a “document”. In a manner similar to the event collecting destination site registering unit 18, for example, the user previously examines the URLs of the information collecting destination sites 14-1 to 14-3 and also registers them into the information collecting destination site registering unit 20.

The event detecting unit 22 obtains information from the event collecting destination sites 12-1 to 12-3 registered in the event collecting destination site registering unit 18, detects the presence or absence of the event occurrence from the presence or absence of an update serving as a changed area of the obtained information, displays the fact that there is a change in information of the event collecting destination sites to the display unit 34 via the information notifying unit 28, and notifies the user of such a fact.

The keyword extracting unit 24 extracts a keyword from the updating area of the information in the event collecting destination sites detected by the event detecting unit 22, that is, from the changed area. In the keyword extraction, for example, the keyword as a noun is extracted by a morpheme analysis of the text document in the updating area.

The used keywords extracted by the past event detection have been registered in the keyword database 30 provided for the keyword extracting unit 24. Therefore, when the keyword is extracted by the new event detection, the keyword extracting unit 24 refers to the keyword database 30. If it coincides with the keyword which has already been registered, since this means that the information collection by the extracted keyword has been finished, the keyword is abandoned. If the keyword is not registered in the keyword database 30, it is outputted as a new keyword to the information searching unit 26.

The information searching unit 26 searches the information collecting destination sites 14-1 to 14-3 registered in the information collecting destination site registering unit 20 by using the keyword detected by the keyword extracting unit 24, thereby obtaining the document including the keyword.

Further, the information notifying unit 28 displays the existence of the document as a search result obtained from one of the information collecting destination sites 14-1 to 14-3 as search results searched by the information searching unit 26 on the basis of the keyword to the display unit 34 and notifies the user of it.

The document storing unit 32 is provided for the information searching unit 26 of the information collecting apparatus 10. The document storing unit 32 stores the document obtained as a search result of the information searching unit 26, the documents which have previously been obtained from the event collecting destination sites 12-1 to 12-3 serving as registration destinations of the event collecting destination site registering unit 18 prior to the information collecting process, or the like.

The document storing unit 32 uses a hard disk drive HDD as a storing destination side and has a function of storage control to the hard disk drive HDD. This point is also similarly applied to the event collecting destination site registering unit 18, the information collecting destination site registering unit 20, and further, the keyword database 30. Areas in the hard disk drive HDD have been allocated as storing destinations to them, respectively. In addition to it, the document storing unit 32 also has registration control and a control function of a database access.

Further, information collecting apparatuses 10-1 and 10-2 having substantially the same construction as that of the information collecting apparatus 10 of the invention are connected to the Internet 11 in FIGS. 1A and 1B and they are the information collecting apparatuses of the invention which are used by other users.

There is a case where an information collecting destination list server 15-1 and an event collecting destination list server 15-2 are connected to the Internet 11. In the information collecting apparatus 10 of the invention, when the information collecting destination sites and the event collecting destination sites are registered, the information collecting destination list server 15-1 and the event collecting destination list server 15-2 are accessed and lists of the respective collecting destinations can be collected and registered into the information collecting destination site registering unit 20 and the event collecting destination site registering unit 18.

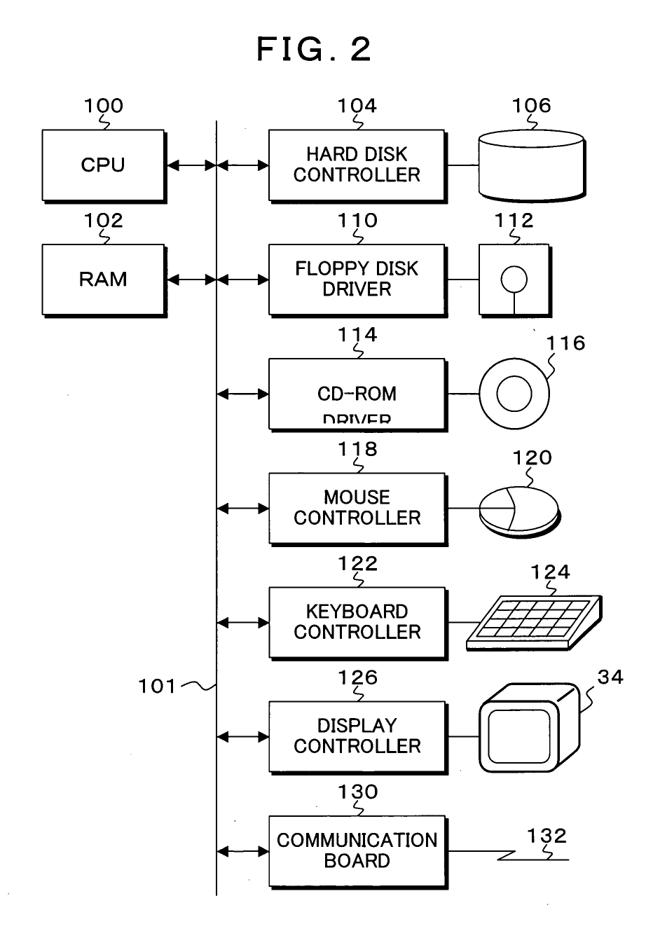

The information collecting apparatus 10 of the invention in FIGS. 1A and 1B is realized by, for example, hardware resources of a computer as shown in FIG. 2.

In the computer in FIG. 2, a RAM 102, a hard disk controller (software) 104, a floppy disk driver (software) 110, a CD-ROM driver (software) 114, a mouse controller 118, a keyboard controller 122, a display controller 126, and a communicating board 130 are connected to a bus 101 of a CPU 100.

The hard disk controller 104 connects a hard disk drive 106. An application program for executing the information collecting process of the invention has been loaded in the hard disk controller 104. Upon activation of the computer, the necessary program is called from the hard disk drive 106, developed onto the RAM 102, and executed by the CPU 100.

A floppy disk drive (hardware) 112 is connected to the floppy disk driver 110 and the reading and writing operations from/to a floppy disk (R) can be executed. A CD drive (hardware) 116 is connected to the CD-ROM driver 114 and can read data and a program stored in a CD.

The mouse controller 118 transfers the inputting operation of a mouse 120 to the CPU 100. The keyboard controller 122 transfers the inputting operation of a keyboard 124 to the CPU 100. The display controller 126 allows the display unit 34 to display. The communicating board 130 communicates with another computer or server via the network such as an Internet or the like by using a communication line 132 including radio communication.

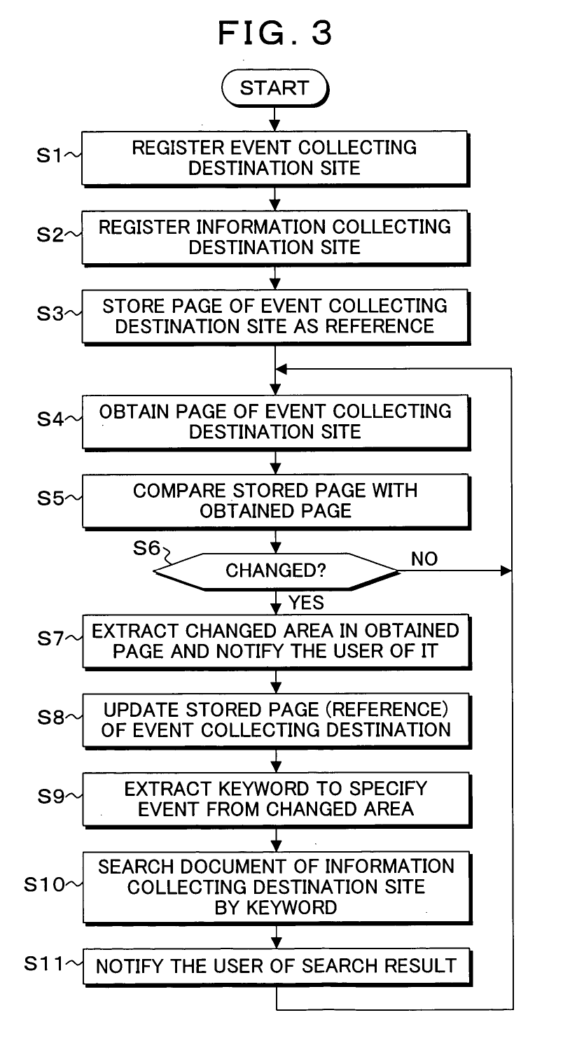

FIG. 3 is a flowchart showing a fundamental processing procedure of the information collecting process of the invention by the information collecting apparatus 10 in FIGS. 1A and 1B. This flowchart corresponds to an embodiment of an application program for information collection according to the invention.

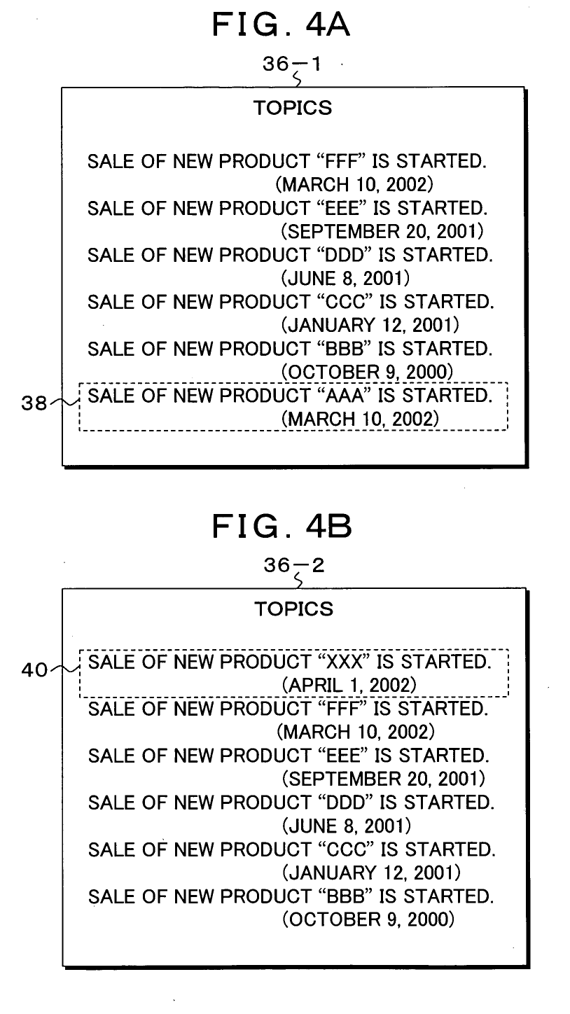

In FIG. 3, first, in step S1, an event collecting destination site is registered into the event collecting destination site registering unit 18. For example, a URL of a page of topics of A company is registered here as an event collecting destination site. By accessing the event collecting destination site by using the URL of the topics of A company, for example, a document 36-1 regarding new product information as shown in FIG. 4A can be obtained.

Subsequently, in step S2, an information collecting destination site is registered into the information collecting destination site registering unit 20. This information collecting destination site can be the homepage of A company or another information collecting destination site in which product introduction including the products of the same business type as that of A company, or the like is made or the like can be registered.

In next step S3, by accessing the page of the topics of A company serving as an event collecting destination site, the document 36-1 of the new product information as shown in FIG. 4A is downloaded and stored as a reference. In the document 36-1 of the new product information in FIG. 4A which is stored as a reference, for example, with respect to new products “AAA” to “FFF”, the start of their sale and its year, month, and date have been described.

Subsequently, in step S4, by accessing periodically the registered event collecting destination site, the documents are downloaded. In step S5, the reference serving as a stored page is compared with the obtained pages. In step S6, whether there is a change or not is discriminated.

It is now assumed that, for example, a document 36-2 of the new product information as shown in FIG. 4B was obtained by such periodic downloading of the page of the event collecting destination site. In the document 36-2 of the new product information, when it is compared with the document 36-1 as a reference in FIG. 4A, information 38 regarding the oldest new product “AAA” at the bottom of the document 36-1-as a reference has been deleted, and information 40 of a new product “XXX” has been added at the top.

The oldest information 38 deleted from the document 36-1 as a reference in FIG. 4A is assumed to be an abandoned area. The new information 40 newly added to the document 36-2 in FIG. 4B is assumed to be an updating area.

As mentioned above, if there is a change in the reference 36-2 newly obtained as compared with the document 36-1 as a reference in FIG. 4A, in step S7, the new information 40 serving as an updating area of the obtained document 36-2 in FIG. 4B is extracted and the user is notified of the event occurrence. After that, the reference serving as a stored page is updated in step S8.

Subsequently, in step S9, with respect to the new information 40 as an updating area in FIG. 4B as a target, the keyword extracting unit 24 extracts the keyword for specifying the detected event occurrence. In the example, “XXX” as a name of the new product is extracted as a keyword.

The keyword extracted as mentioned above is sent to the information searching unit 26. In next step S10, the information searching unit 26 searches the documents of the registered information collecting destination sites by the keyword. In step S11, a search result is displayed to the display unit 34 by the information notifying unit 28 and the user is notified of it.

As an information search by the keyword, by the search using the product name “XXX” of A company as a keyword extracted by the event occurrence, information such as reputation, review, drawback, retail price, and the like which do not exist in the site of A company can be automatically collected and provided to the user.

If the user wants to collect information regarding a computer virus by using the information collecting apparatus 10 of the invention, in step S1, a URL of an antivirus software developing company is preliminarily registered into the event collecting destination site. A homepage of a manufacturer of the personal computer is registered into the information collecting destination site in step S2.

Thus, the incidence of a new virus is detected by the detection of the event occurrence due to the access of the event collecting destination site, the useful information showing how to cope with the new virus as a user of the personal computer is automatically collected by the search of the information collecting destination site by the keyword such as a virus name or the like extracted by the detection of the incidence of the new virus, and it can be shown to the user.

As mentioned above, in the information collecting apparatus of the invention, the specific site is monitored as an event collecting destination site, if the information in this event collecting destination site has been updated, the keyword to specify the event such as announcement of a new product, incidence of the new virus, or the like is formed from contents of the update, and the information including the keyword is collected from the information collecting destination site by this keyword. Thus, the user does not need to set a word for specifying the information such as a keyword or the like. Therefore, even in the unknown information to the user, the information collecting apparatus 10 can collect the necessary information from a plurality of information providing destinations in place of the user and provide it to the user.

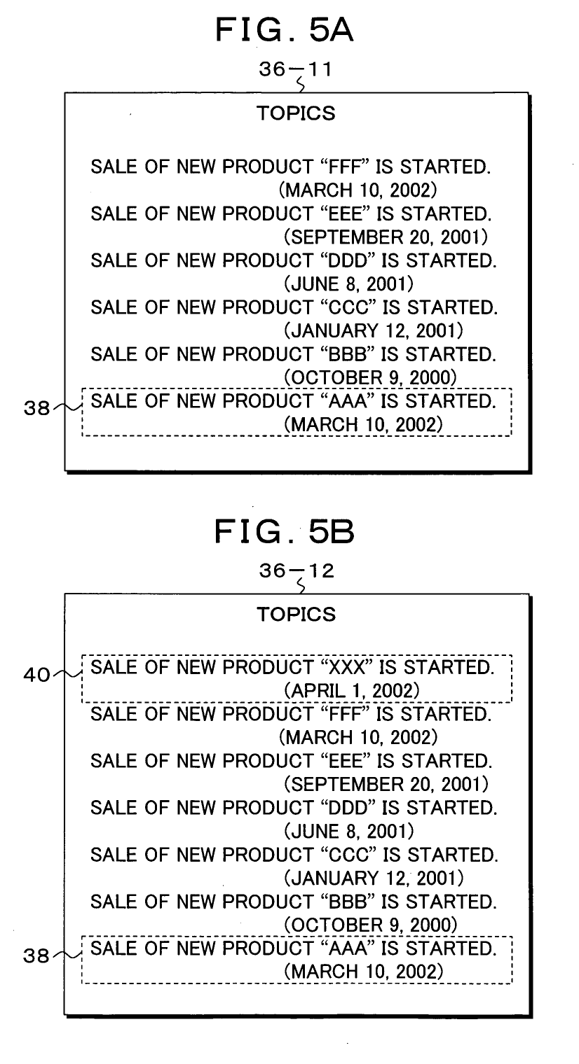

As a form of updating by the addition of the new information in the event collecting destination site, besides the form in which the oldest information 38 is deleted as shown in FIG. 4A and the new information 40 is added as shown in FIG. 4B, there is also a case where the new information is added without deleting the old information as shown in FIGS. 5A and 5B.

FIG. 5A shows a document 36-11 of a new product obtained first in a manner similar to that in FIG. 4A. Subsequent to it, a document 36-12 as shown in FIG. 5B is obtained by the addition of the information 40 of the new product. In the document 36-12 including the added information 40, the information 38 of the oldest new product “AAA” is not deleted but left and the information 40 of the new product “XXX” is added to the head. Naturally, there is also a case of using a form of updating the new information obtaining by combining both of FIGS. 4A and 4B and FIGS. 5A and 5B in accordance with the site.

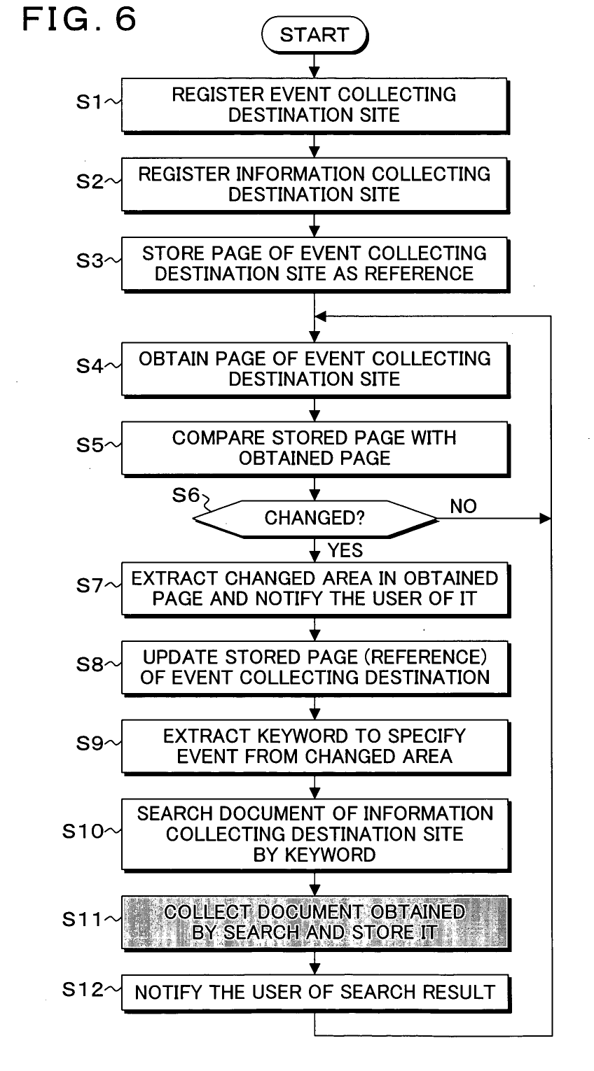

FIG. 6 is a flowchart for a processing procedure in another embodiment of the information collecting apparatus 10 in FIGS. 1A and 1B. The embodiment of FIG. 6 is characterized in that the document obtained by the search of the information collecting destination site using the keyword extracted by the keyword extracting unit 24 on the basis of the detection of the event occurrence in the information searching unit 26 is stored into the document storing unit 32.

That is, steps S1 to S10 in FIG. 6 are substantially the same as those in FIG. 3. In step S11, the documents obtained by the information searching unit 26 by using the keyword are stored into the document storing unit 32. When the documents collected by the search are stored, the keyword used in the search and the collected documents are linked and stored into the document storing unit 32.

In this manner, the documents searched on the basis of the keyword are downloaded from the information collecting destination sites and stored into the document storing unit 32 constructed by the external storing device such as a hard disk drive or the like, so that even if the information is deleted from the information collecting destination sites after that, the user can use it anytime by accessing the document storing unit 32 of the information collecting apparatus 10 itself by using, for example, the keyword as an index with respect to the necessary document.

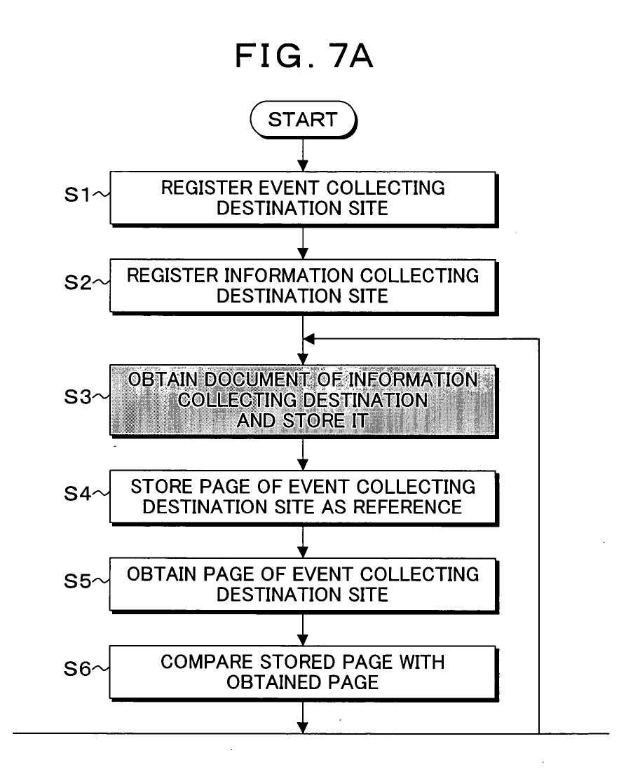

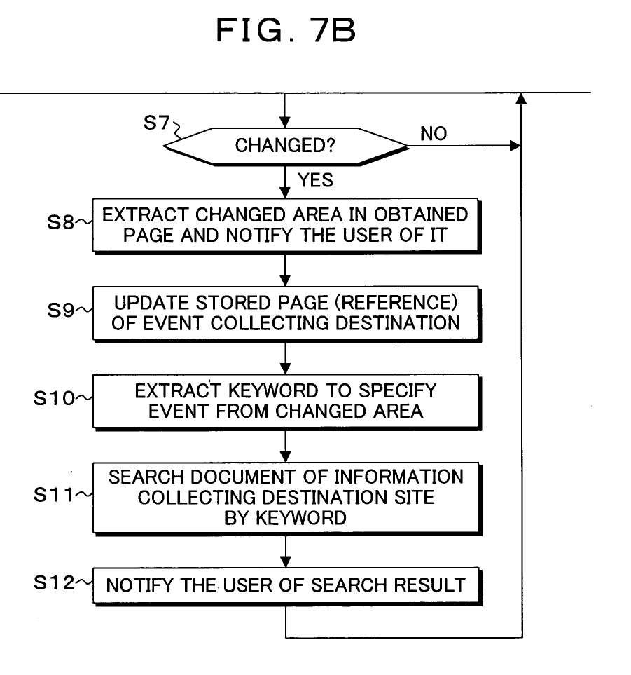

FIGS. 7A and 7B are flowcharts for a processing procedure of another embodiment in the information collecting apparatus 10 in FIGS. 1A and 1B. The embodiment of FIGS. 7A and 7B is characterized in that prior to the information search by the event detection, first, the documents are obtained from the information collecting destination sites 14-1 to 14-3 and stored into the document storing unit 32, and when the event occurrence is detected by the event detecting unit 22, the information searching unit 26 executes the information search to the documents, as targets, stored in the document storing unit 32 by using the keyword extracted by the keyword extracting unit 24.

In the information collecting process in FIGS. 7A and 7B, after the event collecting destination sites were registered in step S1, when the information collecting destination sites are registered in step S2, the documents are obtained from the registered information collecting destination sites and stored into the document storing unit 32 in step S3.

Thus, in step S3 and subsequent steps, the information search based on the event occurrence is made to the documents, as targets, of the information collecting destinations stored in the document storing unit 32 of the information collecting apparatus 10 itself without newly obtaining the documents from the information collecting destination sites on the network.

That is, by processes in steps S4 to S12, in a manner similar to the case of steps S3 to S11 in FIG. 3, there are executed the detection of the event occurrence, the extraction of the changed area due to the detection of the event occurrence, the extraction of the keyword from the changed area, the search of documents stored in the document storing unit 32 using the keyword, and the notification of the search result to the user.

The process for previously storing the documents of the information collecting destination sites and searching them in FIGS. 7A and 7B as mentioned above is suitable in the case where the information is registered into the information collecting destination sites first and the information is stored into the event collecting destination sites later on in dependence on the kind of information.

When the event occurrence is detected in the event collecting destination sites, if the corresponding information has already been deleted from the information collecting destination sites in which the information had already been registered, in the embodiment of FIGS. 7A and 7B, the information in the information collecting destination sites is preliminarily stored into the document storing unit 32, thereafter, the event occurrence is detected, and the search is made to the documents, as targets, stored in the document storing unit 32. Therefore, even after the information has already been deleted in the information collecting destination sites on the network, the information search by the keyword based on the event occurrence is certainly made and the information can be provided to the user.

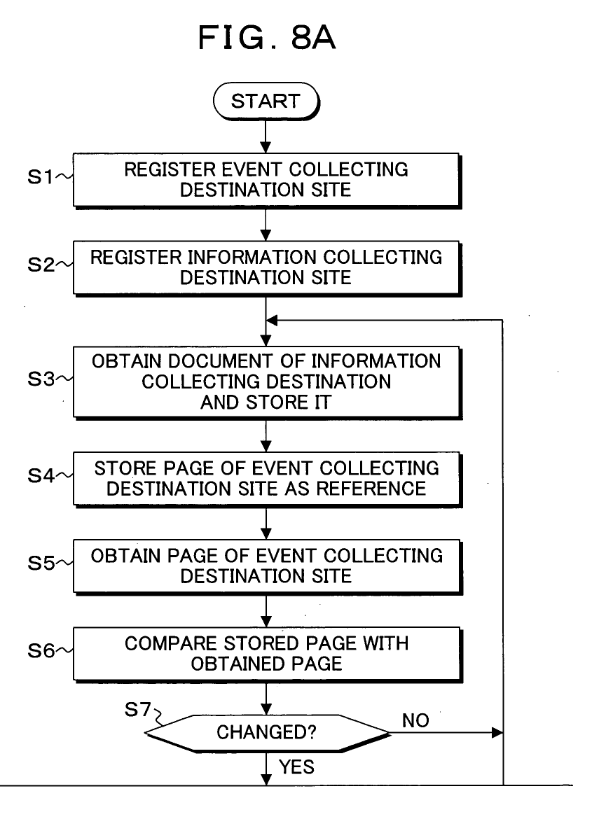

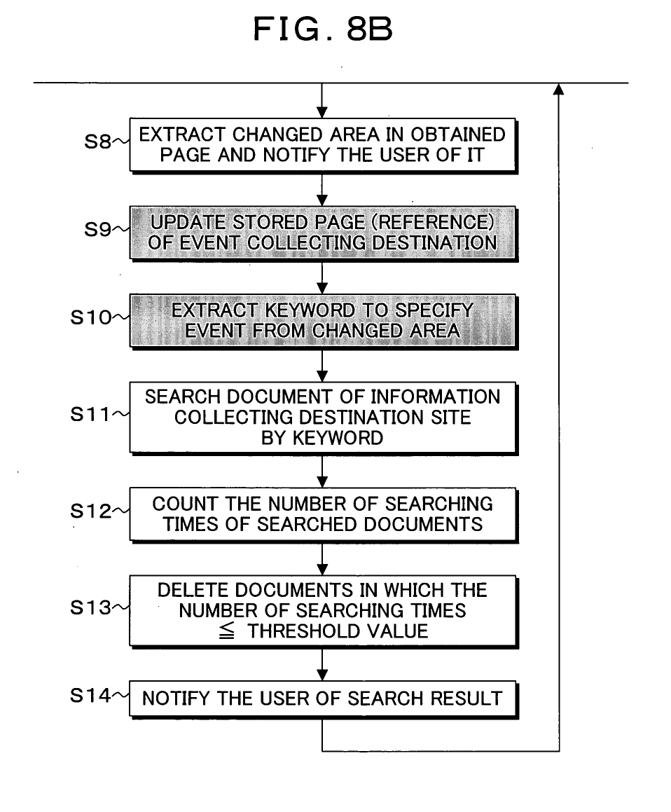

In FIGS. 8A and 8B, with respect to the embodiment in which the information collection based on the event occurrence is made after the documents in the information collecting destination sites were previously stored in the document storing unit 32 like an embodiment of FIGS. 7A and 7B, if the document collection is continued, the external storing device such as a hard disk drive or the like constructing the document storing unit 32 is filled and a new document cannot be stored. Therefore, to avoid such a situation, a process for periodically deleting the documents is added.

In FIG. 8A, steps S1 to S11 are substantially the same as those in the embodiment of FIGS. 7A and 7B. In processes in steps S12 to S14 in FIG. 8B subsequent to FIG. 8A, the process for deleting the documents from the document storing unit 32 is executed.

That is, in step S12, the number of searching times of the documents searched by the information searching unit 26 is counted. The documents whose number of searching times is equal to or less than a threshold value are deleted from the document storing unit 32 in step S13. For example, the threshold value in step S13 is set to 0 and the documents whose number of searching times is equal to 0 are deleted from the document storing unit 32.

Timing for counting the number of searching times in step S12 and timing for deleting in step S13 can be set to other timing. The deletion in step S13 can be made at the time of collection of the documents or it is also possible to additionally hold a timer and execute the deletion at every predetermined time.

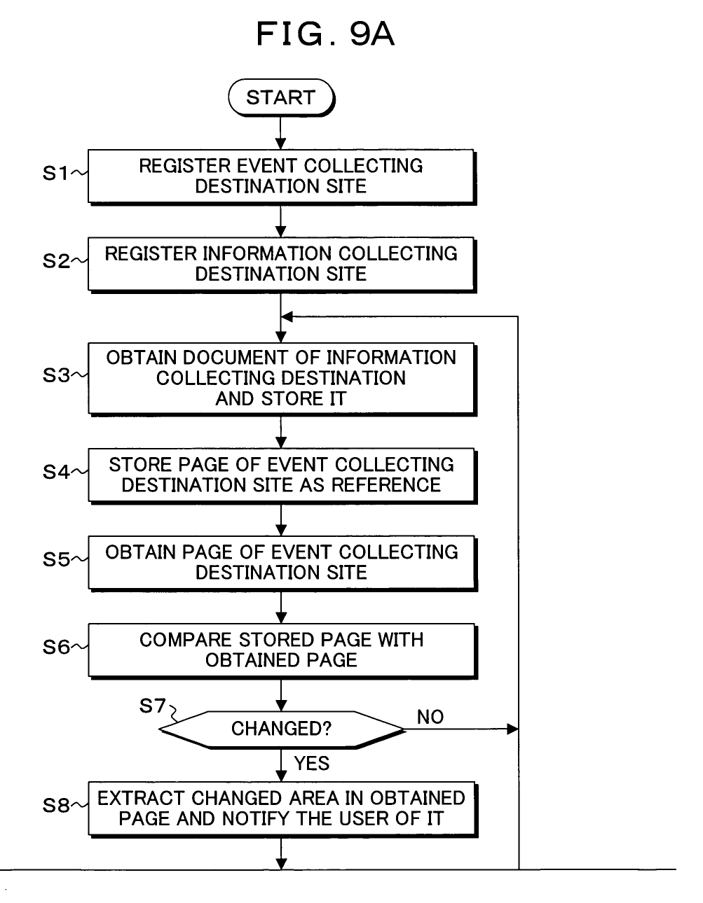

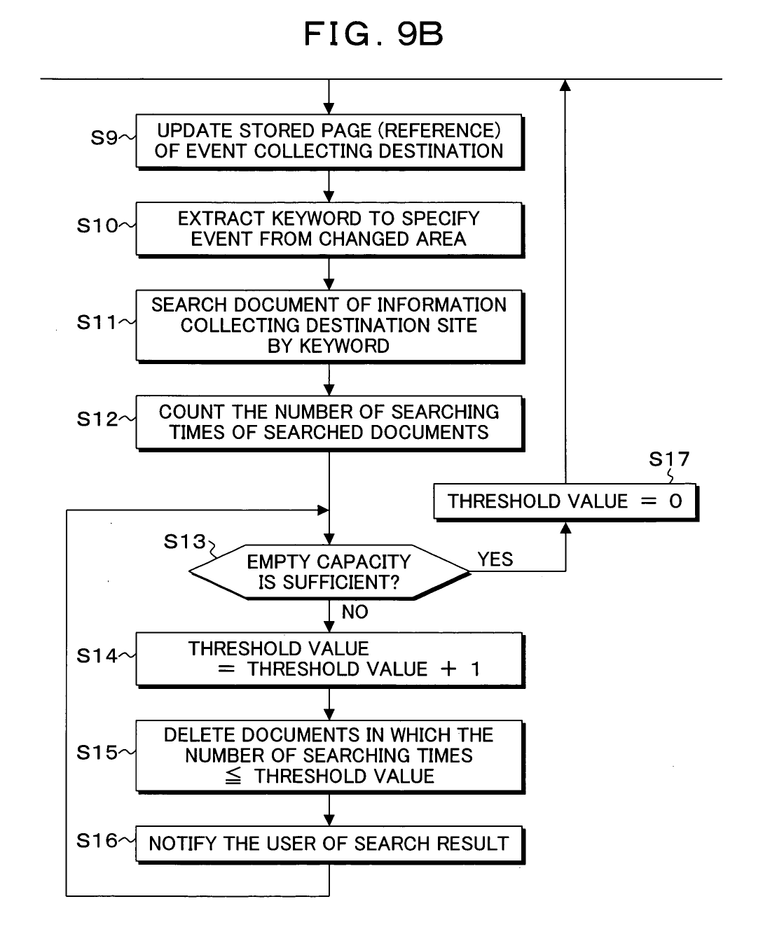

FIGS. 9A and 9B are flowcharts for the information collecting process of the invention including another embodiment for deleting the stored documents. This embodiment is characterized in that in the case where an empty capacity of the document storing unit 32 is insufficient even if the documents whose number of searching times is equal to or less than the predetermined threshold value are deleted, by increasing the threshold value, the empty capacity of the document storing unit 32 is increased.

In FIG. 9A, steps S1 to S11 are substantially the same as those in the embodiment of FIGS. 7A and 7B. A process for changing the threshold value of the number of searching times is executed so as to increase the empty capacity by processes in steps S12 to S17 in FIG. 9B.

That is, after the number of searching times of the searched documents is counted in step S12, whether the empty capacity of the document storing unit 32 is sufficient or not is discriminated in step S13. If the empty capacity is insufficient, step S14 follows and the threshold value is increased by, for example, 1.

Since the threshold value in its initial state is equal to, for example, 0, the threshold value is equal to 1 in step S14. Subsequently, in step S15, the documents whose number of searching times is equal to or less than the increased predetermined threshold value are deleted. Thus, since the threshold value is increased by 1, the number of documents to be deleted can be increased than the number of documents deleted on the basis of the threshold value 0. The empty capacity due to the deletion of the documents can be increased.

If the documents are deleted in step S15, the user is notified of a search result in this instance in step S16. Thereafter, the processing routine is returned to step S13 and whether the empty capacity is sufficient or not is discriminated. Naturally, the discrimination about whether the empty capacity is sufficient or not is made by using the predetermined threshold value of the empty capacity.

If the empty capacity is insufficient, the processes in steps S14 to S16 are repeated. If the sufficient empty capacity can be assured, the threshold value is returned to 0 as an initial value in step S17 and, thereafter, the processes from step S3 in FIG. 9A are repeated.

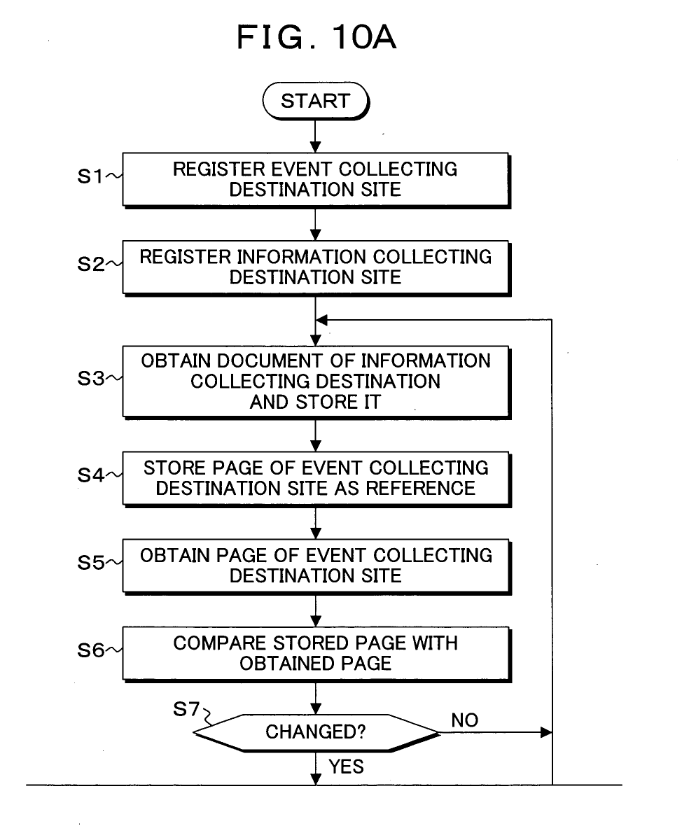

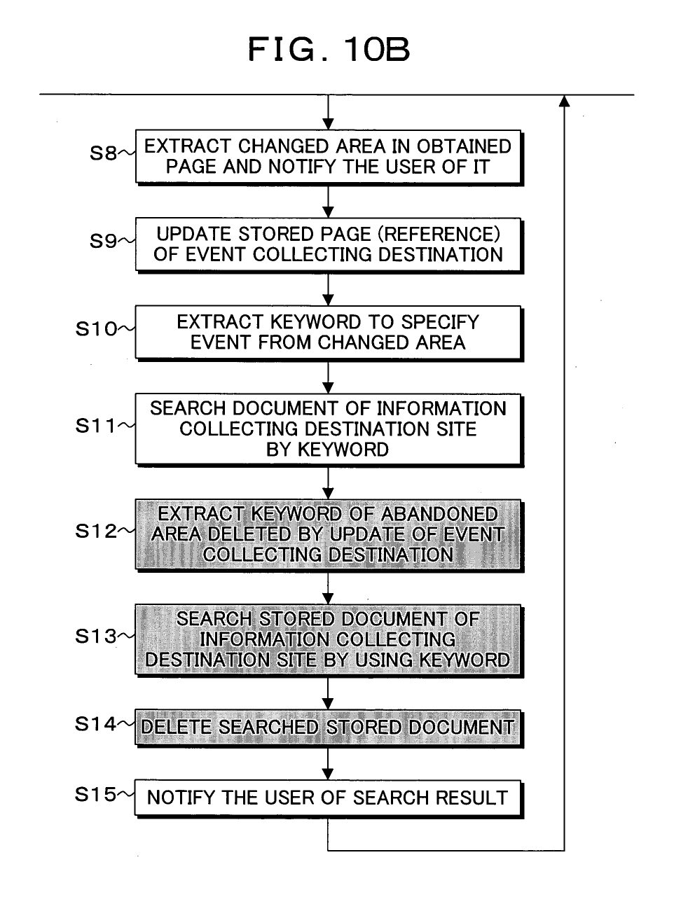

FIGS. 10A and 10B are flowcharts for an embodiment of another processing procedure in the information collecting apparatus of the invention for deleting the documents from the document storing unit. This embodiment is characterized by deleting the stored documents corresponding to the information 38 deleted as an abandoned area which is determined by the comparison between the document 36-1 as a reference obtained from the event collecting destination sites as shown in FIG. 4A and the document 36-2 including the new information as shown in FIG. 4B.

Steps S1 to S11 in FIG. 10A are substantially the same as steps S1 to S11 in FIGS. 7A and 7B. Subsequent to it, a deleting process of the documents corresponding to the deleted information 38 in FIG. 4A is executed in steps S12 to S14 in FIG. 10B.

That is, “AAA” is extracted as a keyword from the information deleted by the page update on the event collecting destination side, for example, from the information 38 in FIG. 4A in step S12. Subsequently, in step S13, the documents of the information collecting destination sites held in the document storing unit 32 are searched by using the extracted keyword “AAA”. Thus, the stored documents corresponding to the keyword “AAA” are searched. They are deleted from the document storing unit 32 in step S14.

By such a deleting process of the stored documents in FIGS. 10A and 10B as mentioned above, the old documents corresponding to the information deleted from the event collecting destination sites due to the detection of the event occurrence can be automatically deleted from the documents stored in the document storing unit 32.

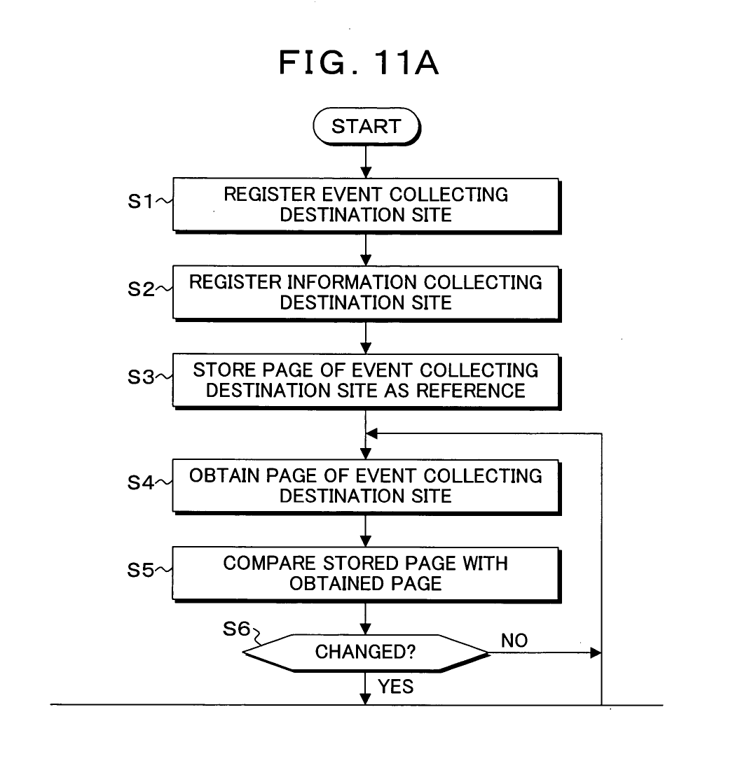

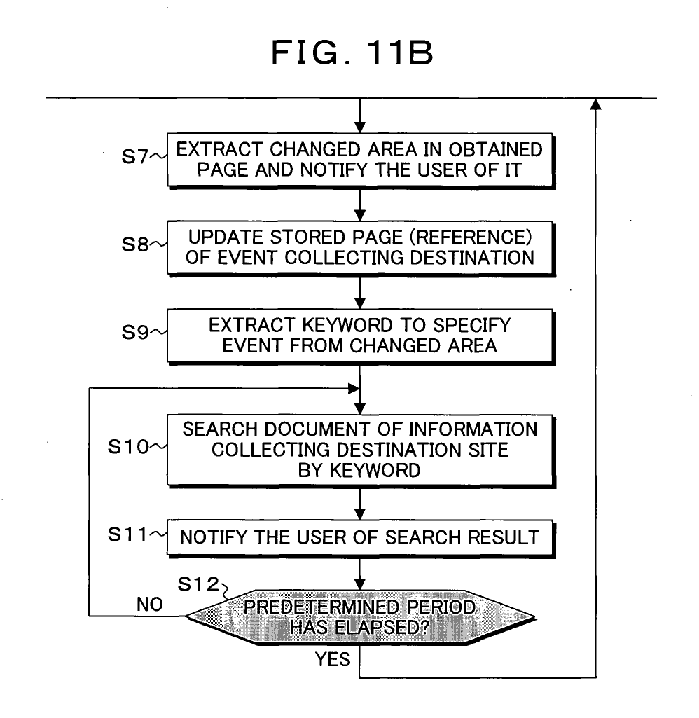

FIGS. 11A and 11B are flowcharts for a processing procedure of another embodiment of the information collecting process of the invention in the information collecting apparatus 10 in FIGS. 1A and 1B. This embodiment is characterized in that the information search to the information collecting destination sites using the keyword extracted by the detection of the event occurrence is periodically and continuously made during a predetermined period of time.

In FIGS. 11A and 11B processes in steps S1 to S11 are substantially the same as those in steps S1 to S11 in FIG. 3. In addition to them, whether a predetermined period of time has elapsed or not is discriminated in step S12. Until the predetermined period of time elapses, the search of the documents of the information collecting destinations by the keyword in steps S10 and S11 is periodically repeated and the user is notified of the search results.

The processes in FIGS. 11A and 11B cope with the time lag of the information registering timing in each site in the case where the event collecting destination site and the information collecting destination site are different. That is, there is a case where even if the event occurrence is detected from the event collecting destination site, information is not registered yet in the information collecting destination site and the necessary information cannot be obtained.

In such a case, in the embodiment of FIGS. 11A and 11B, by discriminating whether the predetermined period of time has elapsed or not in step S12, the information search using the keyword is repeated by the repetition of the processes in steps S10 and S11, so that the omission of the information collection due to the time lag of the information registering timing to the information collecting destination site can be prevented.

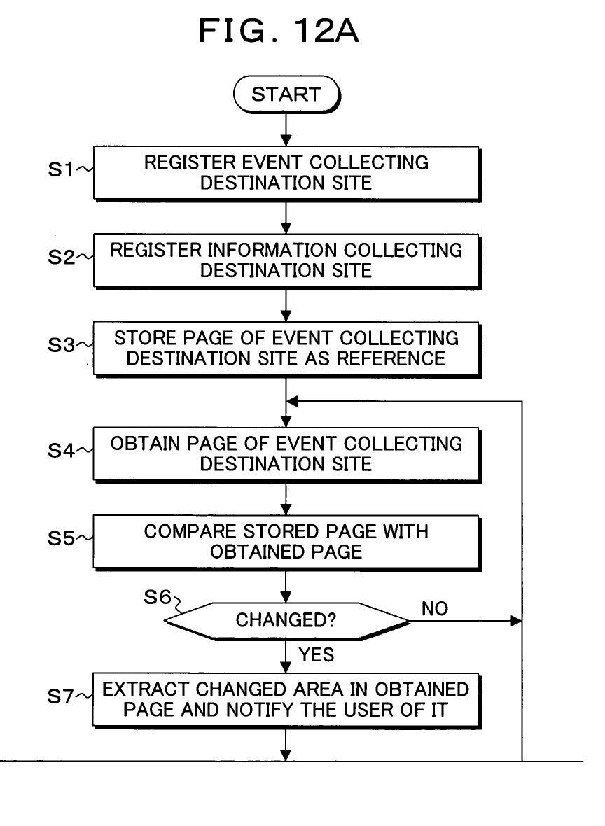

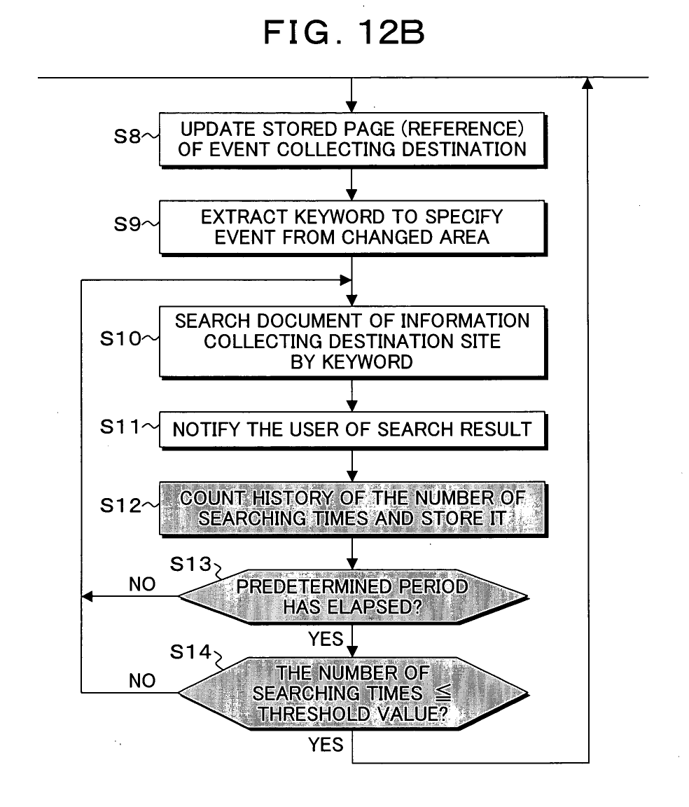

FIGS. 12A and 12B are flowcharts for another embodiment of an information collecting process of the invention for preventing the omission of the information collection due to the time lag of the information registering timing to the information collecting destination site which cannot be covered in the embodiment of FIGS. 11A and 11B.

That is, in the embodiment of FIGS. 11A and 11B, the information search by the keyword is periodically repeated until the elapse of the predetermined time, thereby preventing the omission of the information collection even if there is a time lag due to the information registration of the information collecting destination site. However, there is a case where the information cannot be collected either in dependence on a duration of the time lag.

In the embodiment of FIGS. 12A and 12B, therefore, the number of searching times as an information search result using the keyword is held and, if the number of searching times during a predetermined period of time is equal to or less than a predetermined threshold value, it is determined that the novelty of the event faded, and the information collection using the keyword is stopped.

Steps S1 to S11 in FIG. 12A are substantially the same as those in steps S1 to S11 in FIGS. 11A and 11B. By processes in steps S12 to S14 in FIG. 12B subsequent to them, a fact that the novelty of the event faded is discriminated and the information collection is stopped. That is, histories of the number of searching times are counted and stored in step S12. Whether the predetermined period of time has elapsed or not is discriminated in step S13. If the predetermined period of time has elapsed, whether the number of searching times is equal to or less than a threshold value or not is discriminated in step S14.

If the number of searching times exceeds the threshold value, it is determined that the novelty of the event is high. The search of the documents of the information collecting destination sites by the keyword from step S10 in FIG. 12A is repeated.

If the number of searching times is equal to or less than the threshold value in step S14, it is determined that the novelty of the event faded. The document search of the information collecting destination sites by the keyword from step S10 is stopped. The processing routine is returned to step S4 in FIG. 12A and the processes are repeated from the searching process of the information of a new event collecting destination site.

It is also possible to construct in a manner such that a process for discriminating the elapse of a predetermined period of time in step S13 in FIG. 12B is excluded, histories of the search results are counted and stored in step S12, if the number of searching times is equal to or less than the threshold value, the information search is immediately stopped, and the processing routine is returned to step S4 in FIG. 12A.

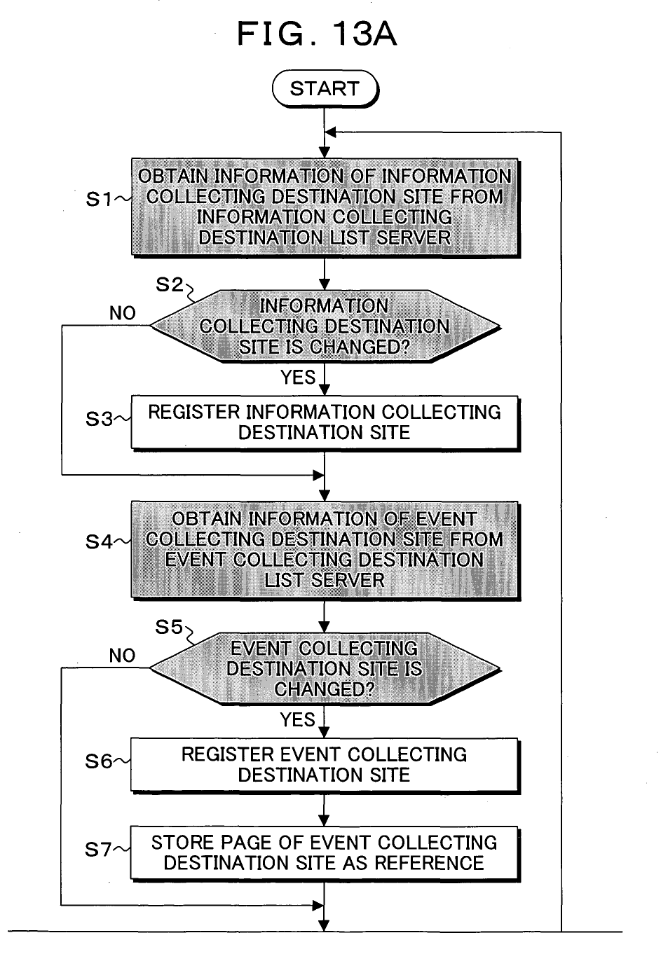

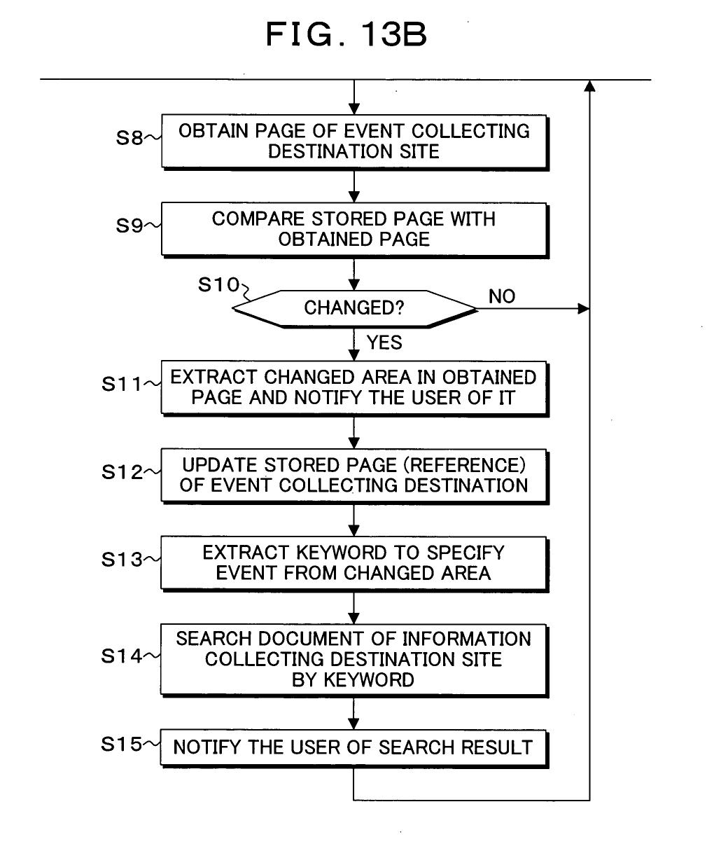

FIGS. 13A and 13B are flowcharts for another embodiment of the information collecting process according to the invention in the information collecting apparatus 10 in FIGS. 1A and 1B. The embodiment is characterized in that the information of the event collecting destination sites and the information collecting destination sites is obtained from the server on the Internet.

In the embodiment of FIGS. 13A and 13B, the event collecting destination list server 15-2 and the information collecting destination list server 15-1 connected to the Internet 11 in FIGS. 1A and 1B are used. In the Internet, a change in address (URL) of the WWW server, disuse of the server itself, or the like can occur frequently.

In the event collecting destination list server 15-2, therefore, the event collecting destination site is set and its information is provided to the information collecting apparatus 10 of the invention as a client, so that the user of the information collecting apparatus 10 as a client can register an event collecting destination list into the event collecting destination site registering unit 18 without worrying about in which server the event collecting destination site exists or the like.

This point is also similarly applied to the site registration into the information collecting destination site registering unit 20. The information collecting destination site is set by the information collecting destination list server 15-2 and its information is provided to the information collecting apparatus 10 as a client, so that the user can register the information collecting destination site into the information collecting destination site registering unit 20 without worrying about a state of the server of the information collecting destination site and use the information search.

In correspondence to the event collecting destination list server 15-2 and the information collecting destination list server 15-1, in the processes in FIG. 13A, first, the information of the information collecting destination sites is obtained from the information collecting destination list server 15-1 in step S1. In step S2, it is compared with contents registered in the information collecting destination site registering unit 20. If there is a change, a URL of the new information collecting destination site is registered into the information collecting destination site registering unit 20 in step S3.

In step S4, the information of the event collecting destination sites from the information collecting destination list server 15-2 is collected. It is compared with contents registered in the event collecting destination site registering unit 18. If there is a change in the event collecting destination site, the new changed event collecting destination site is registered into the event collecting destination site registering unit 18 in step S6. Further, a page of the event collecting destination site newly registered is stored as a reference in step S7.

Processes in steps S8 to S15 subsequent to them are substantially the same as those in steps S4 to S11 in FIG. 3.

In the embodiment of FIGS. 13A and 13B, the information of the sites is obtained from both of the information collecting destination list server 15-1 and the information collecting destination list server 15-2 registered. However, it is also possible to obtain the information from either of them and execute the site registration.

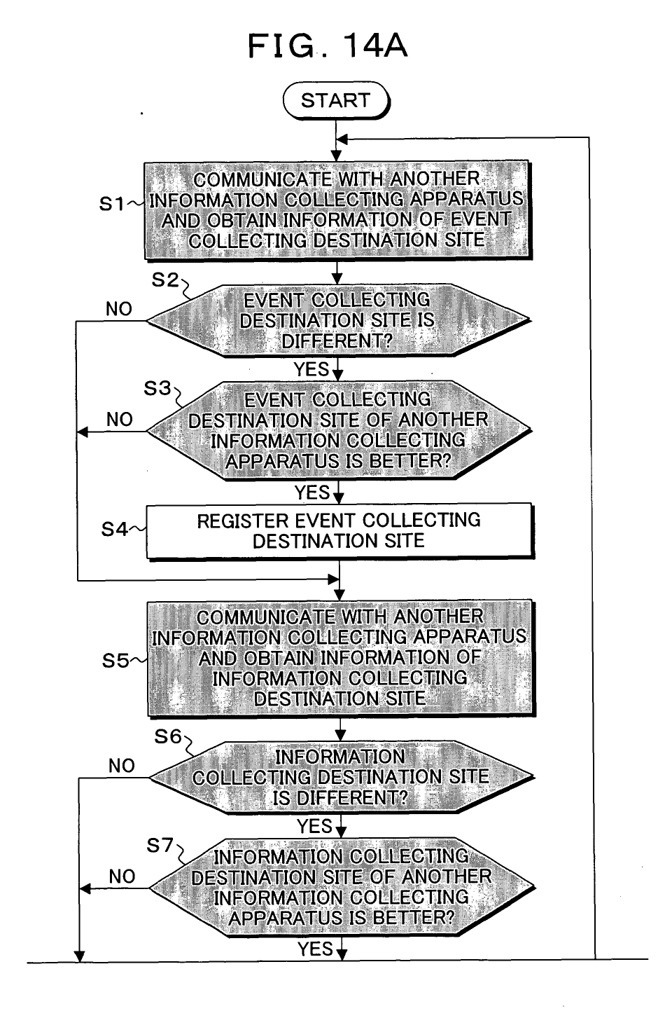

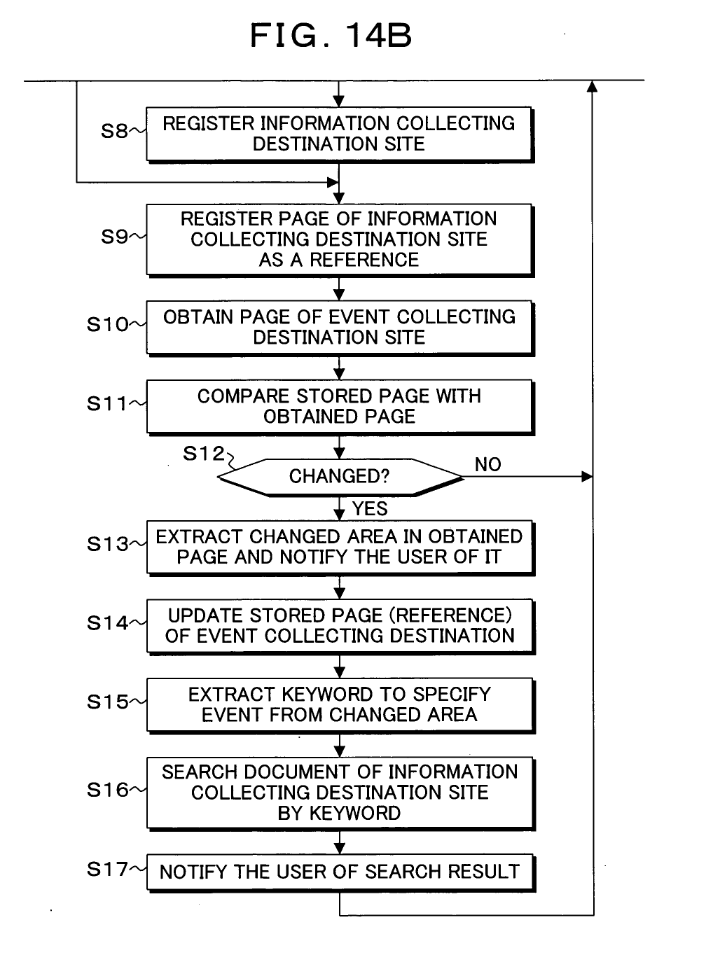

FIGS. 14A and 14B are flowcharts for another embodiment of the information collecting process according to the invention in the information collecting apparatus 10 in FIGS. 1A and 1B. The embodiment is characterized in that the information of the event collecting destination sites and the information collecting destination sites is obtained from other information collecting apparatuses 10-1 and 10-2 connected to the Internet 11 in FIGS. 1A and 1B and having substantially the same construction as that of the invention.

In the embodiment of FIGS. 14A and 14B, a network environment in which the information collecting apparatus 10 of the invention collects the information of the event collecting destination sites and the information collecting destination sites from other information collecting apparatuses 10-1 and 10-2 having substantially the same construction is obtained in the case where the information collecting apparatuses 10-1 and 10-2 construct the peer-to-peer system in which each of them mutually uses the information on the partner side as a peer machine.

In FIG. 14A, in step S1, the information collecting apparatus 10 of the invention communicates with, for example, the other information collecting apparatus 10-1 and obtains the information of the event collecting destination sites registered in the other information collecting apparatus 10-1.

With respect to the event collecting destination sites obtained from the other information collecting apparatus 10-1, they are compared with the contents in the own event collecting destination site registering unit 18. If the event collecting destination sites are different, whether the event collecting destination sites of the other information collecting apparatus 10-1 are better or not is discriminated in step S3.

As discriminating conditions of the event collecting destination sites in step S3, a degree of good and bad of the event collecting destination site is evaluated by a numerical value on the basis of information amounts such as information obtainment time/date showing a speed of the information registration, the number of bytes of the document, and the like. The obtained numerical value is compared with a numerical value similarly obtained by the other information collecting apparatus 10-1 and the better one of them is used. In step S4, the used event collecting destination sites collected from the other information collecting apparatus 10-1 are registered into the own event collecting destination site registering unit 18.

In step S5, the registered information of the information collecting destination site is obtained by communicating with the other information collecting apparatus 10-1. If it differs from the registered site in the own information collecting destination site registering unit 20 in step S6, in a manner similar to the case of the collecting destination sites in step S3, the good and bad of the information collecting destination site of the other information collecting apparatus 10-1 are discriminated by comparing the numerical values. If it is good, the obtained information collecting destination site is registered into the own information collecting destination site registering unit 20 in step S8.

Processes in steps S9 to S17 subsequent to them are substantially the same as those in steps S4 to S11 in FIG. 3.

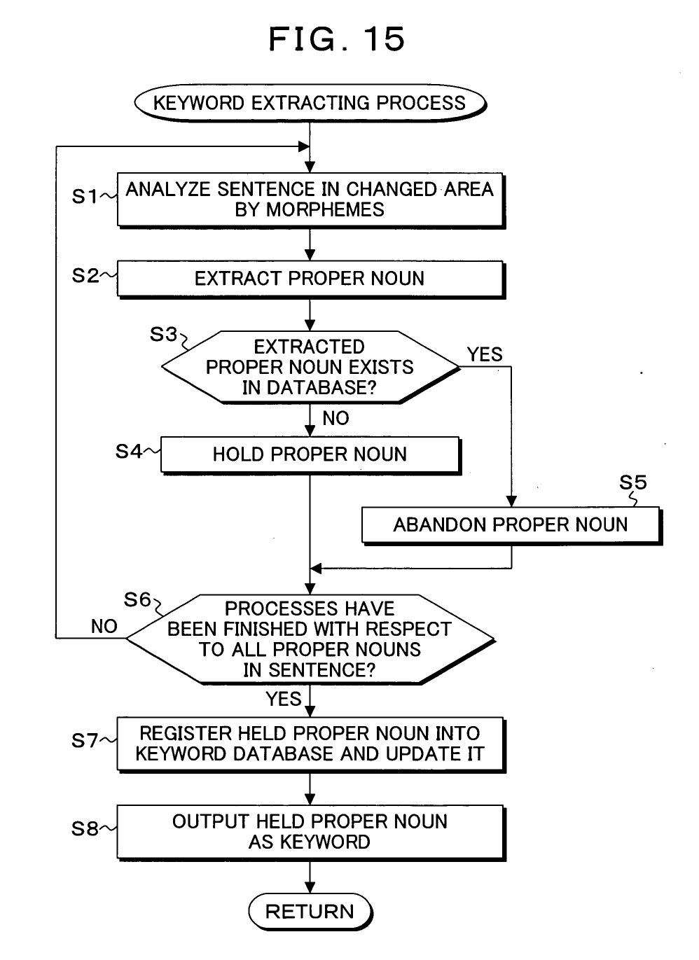

FIG. 15 is a flowchart showing details of the keyword extracting process in the keyword extracting unit 24 in the information collecting apparatus 10 in FIGS. 1A and 1B.

In FIG. 15, in the keyword extracting process, first, in step S1, a changed area of the document obtained from the event collecting destination sites, for example, a sentence of the information 40 in FIG. 4B is morpheme-analyzed and decomposed into parts of speech. Since the sentence in the changed area obtained from the event collecting destination sites includes a proper noun such as product name, virus name, or the like for specifying the event, only the proper noun is extracted from the morpheme-analyzed data in step S2.

Subsequently, in step S3, it is compared with proper nouns in the keyword database 30 and whether it exists in the keyword database 30 or not is discriminated. If it does not exist in the keyword database 30, the proper noun extracted in step S2 is held as a keyword in step S4. If the proper noun has been registered in the keyword database 30 in step S3, since this proper noun has already been used as a keyword, the proper noun is abandoned in step S5.

Such processes in steps S1 to S5 are repeated until they are finished with respect to all proper nouns in the sentence of the changed area in step S6. If the end of the processes is determined in step S6 with respect to all of the proper nouns, the proper noun held in step S4 is registered into the keyword database 30 and updated in step S7. After that, the held proper noun is outputted as a keyword to the information searching unit 26 in step S8.

In the keyword extracting process in FIG. 15, if a plurality of keywords are extracted from the sentence of the changed area of the document obtained from the event collecting destination site, it is also possible to construct in a manner such that significance of those keywords is discriminated, priorities are given to them, the keywords with the priorities are outputted to the information searching unit 26, and the information search is made by using the keywords according to the priorities.

As a method of giving the priorities in which the significance has been discriminated in the case where a plurality of keywords are extracted,

(1) a keyword in which an external link has been set,

(2) a keyword whose number of appearing times in the external link destination document is large,

(3) a keyword surrounded by a special symbol such as ┌ ┘, “ ”, or the like, and,

(4) an emphasis-designated keyword such as bold <B> </B>, red characters, <FONT COLOR=“#ff0000”>, </FONT>, or the like are extracted, peculiar points are given in accordance with extraction contents of the document, and the sum of them is obtained. For example, 3 points are given per keyword in (1) and (2), 10 points are given to the keyword in (3), or the like. The total of the given points is obtained. The priorities are given to the keywords in order from the larger total points.

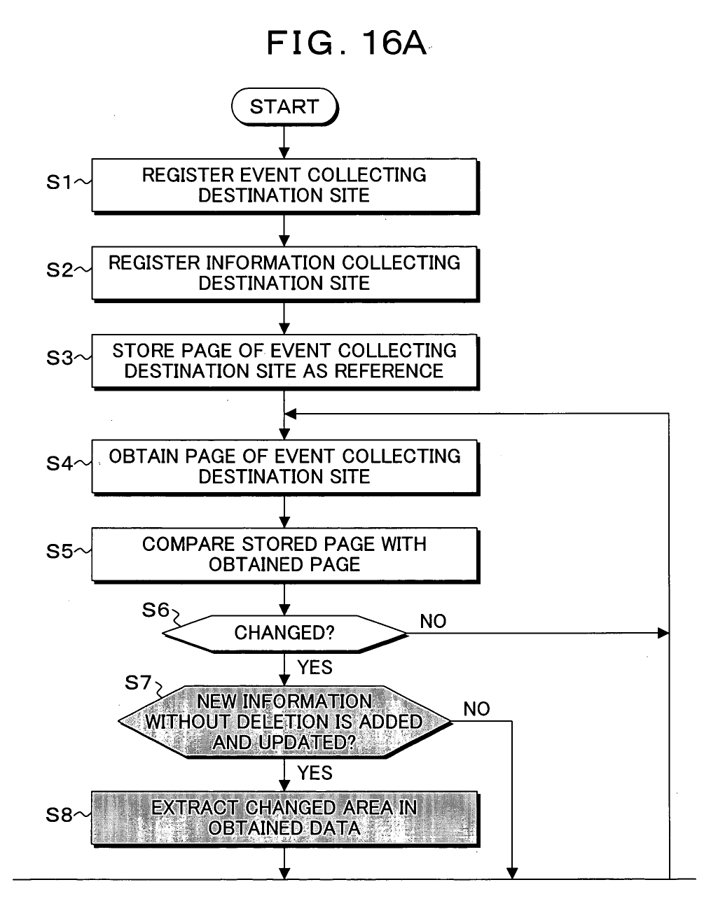

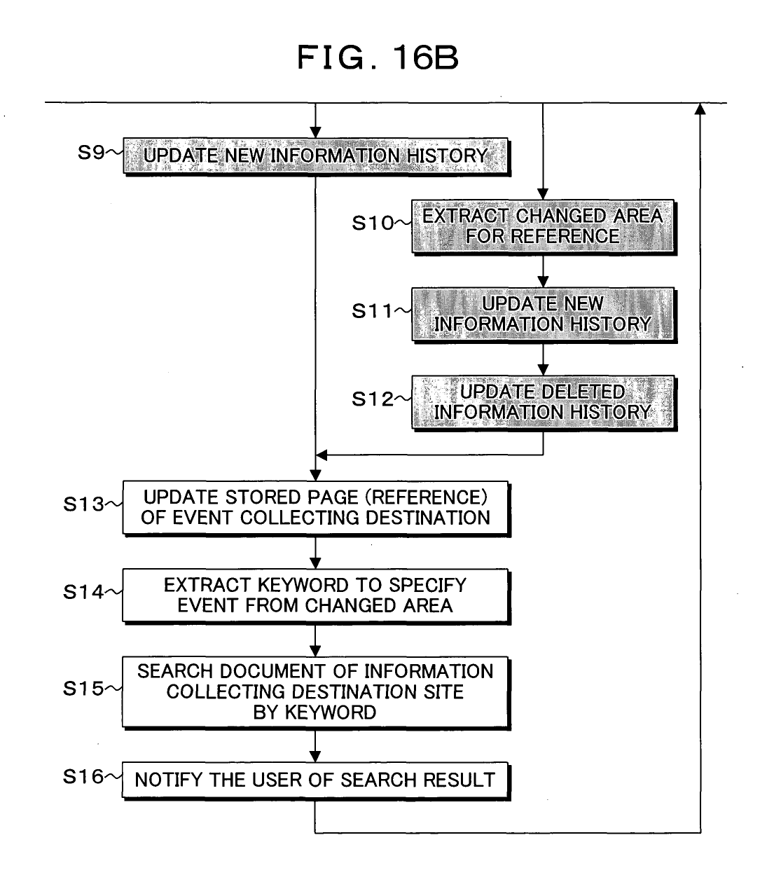

FIGS. 16A and 16B are flowcharts for another embodiment of the information collecting process in the information collecting apparatus 10 in FIGS. 1A and 1B. The embodiment is characterized in that the histories of the new information added to the documents obtained from the event collecting destination site and the deleted information are stored, thereby enabling the user to understand in which time sequence the information on the event collecting destination side has been updated or deleted.

In FIG. 16A, processes in steps S1 to S6 are substantially the same as those in steps S1 to S6 in FIG. 3. The document of the event collecting destination site is compared with the reference and if there is a change in step S6, whether the new information without deletion is added and updated or not is discriminated in step S7.

Upon updating of the document of the event collecting destination site, there are two forms: an updating form in which the old information 38 is abandoned and the new information 40 is added as shown in FIGS. 4A and 4B; and an updating form in which the old information 38 is left and the new information 40 is added as shown in FIGS. 5A and 5B.

Therefore, if the addition and updating of the new information without deletion in FIGS. 5A and 5B is discriminated in step S7, for example, the new information 40 serving as a changed area of the document 36-12 as obtained data in FIG. 5B is extracted in step S8. It is added to the changed area information history, thereby updating.

On the other hand, if the addition and updating of the new information with the deletion as shown in FIGS. 4A and 4B is discriminated in step S7, the document 36-1 as a reference in FIG. 4A is compared with the newly obtained document 36-2 in FIG. 4B. The information 38 serving as an abandoned area of the document 36-1 as a changed area and the new information 40 serving as an added area of the document 36-2 are extracted.

In step S11, the new information history is updated by adding the added new information 40 thereto. In step S12, the deleted information history is updated by adding the deleted information 38 serving as an abandoned area thereto. The user can refer to the new information history and the deleted information history which were updated as mentioned above as necessary and they are displayed as a list in which the histories are arranged in accordance with the time sequence.

After completion of the update history processes in steps S7 to S9 or steps S7 to S12 as mentioned above, the reference as an event collecting destination site stored page is updated by the newly compared document in step S13. In steps S14 to S16 in FIG. 16B, the keyword to specify the event is extracted from the changed area of the event collecting destination site, the document of the information collecting destination site is searched by the keyword, and the user is notified of it.

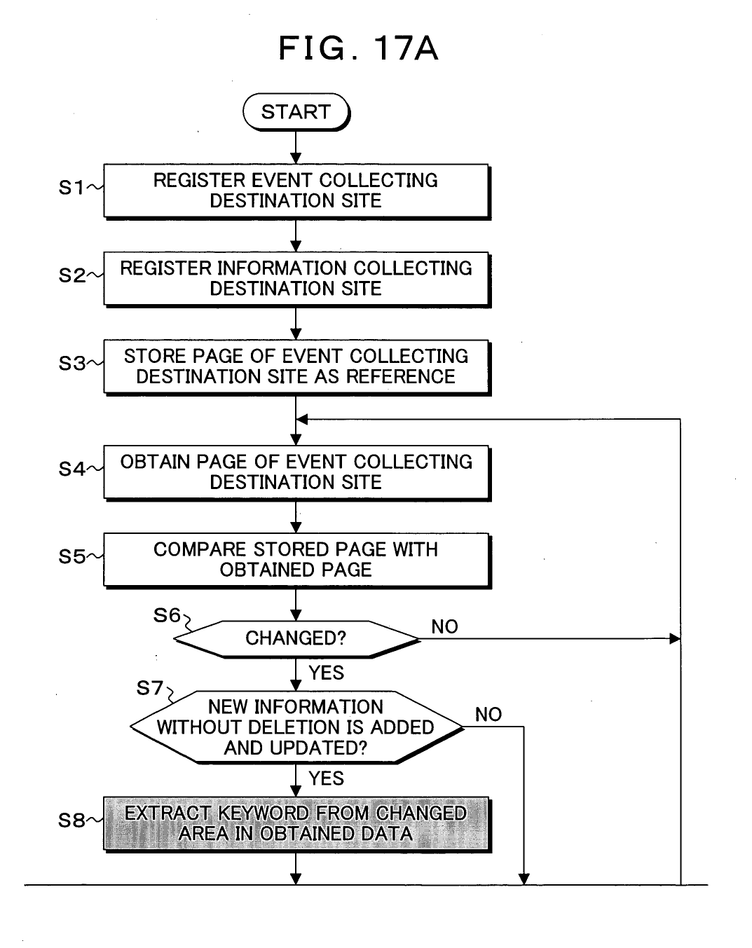

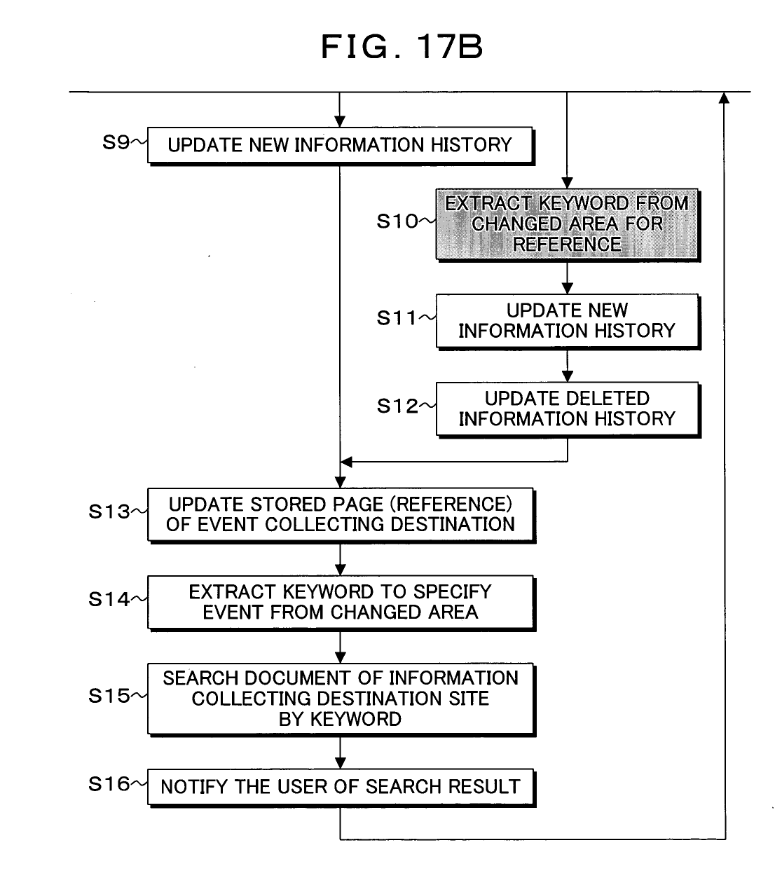

FIGS. 17A and 17B are characterized in that with respect to the storage of the histories of the information list updated with regard to the event collecting destination site, the keyword is extracted from the updated area, thereby enabling the updated history by the keyword to be stored and used.

In FIGS. 17A and 17B, processes in steps S1 to S7, S9, and S11 to S16 are substantially the same as those in the flowcharts of FIGS. 16A and 16B. In steps S8 and S10 in FIG. 17A, the keyword is extracted from the data obtained from the event collecting destination site, that is, from the changed area of the document.

That is, in step S8, for example, “XXX” is extracted as a keyword from the sentence of the information 40 of the changed area of FIG. 5B discriminated in step S7. The new information history is updated by adding the keyword “XXX” thereto in step S9. If the deletion update as shown in FIGS. 4A and 4B is discriminated in step S7, step S10 follows. A keyword “AAA” is extracted from the information 38 which is deleted as an abandoned area in FIG. 4A and the keyword “XXX” is extracted from the information 40 serving as an added area in FIG. 4B. In step S11, the new information history is updated by adding the keyword “XXX” thereto. In step S12, the deleted information history is updated by adding the keyword “AAA” thereto.

Since the new information history and the deleted information history of the document of the event collecting destination site can be stored and used as a list as mentioned above, when the user reads out the new information history and the deleted information history, they are displayed as a keyword list. A time-sequential updating state of the new products can be easily grasped.

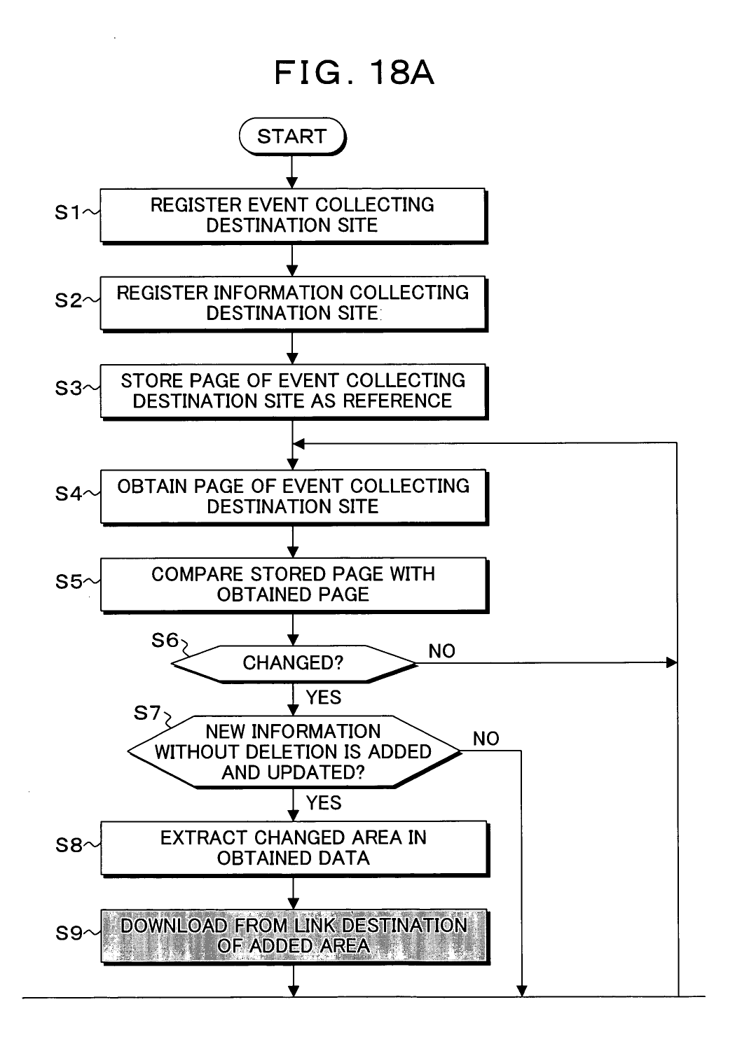

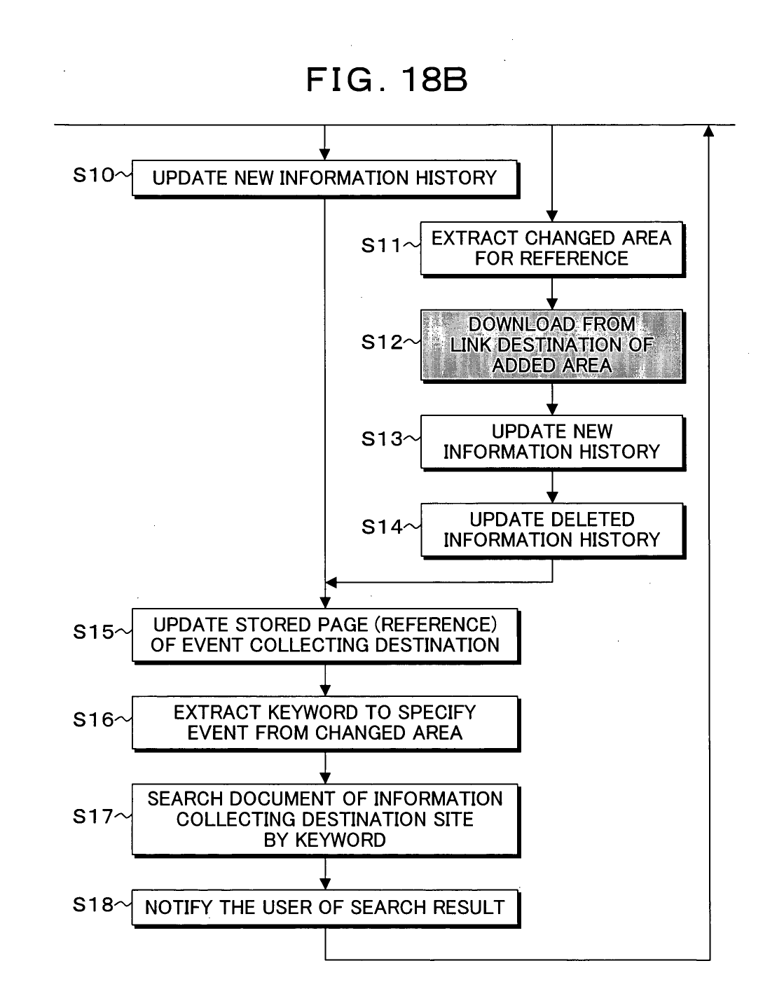

FIGS. 18A and 18B are flowcharts for another embodiment of the information collecting process of the invention in the information collecting apparatus 10 in FIGS. 1A and 1B. The embodiment is characterized in that the document is downloaded from the link destination existing in the changed area obtained by the update of the event collecting destination site and stored.

Processes in steps S1 to S8 and steps S10, S11, and S13 to S18 in the flowcharts of FIGS. 27 and 28 are substantially the same as those in steps S1 to S8 and steps S9 to S16 in FIGS. 17A and 17B. In FIG. 18A, processes in steps S9 and S12 are newly added.

In the process in step S9, if link information of another site is included in the new information 40 downloaded from the event collecting destination site and serving as a changed area as shown in FIGS. 5A and 5B in step S7, by accessing such another site by the link information, the document on the link destination side shown in the changed area is downloaded and stored into the document storing unit 32.

In the process in step S12, if link information of another site is included in the new information 40 downloaded from the event collecting destination site and serving as a changed area as shown in FIGS. 4A and 4B in step S7, by accessing such another site by the link information, the document on the link destination side shown in the changed area is downloaded and stored into the document storing unit 32.

Thus, even if the link information of the update history is deleted by the update of the event collecting destination site, since the document has been stored from the deleted server on the link destination side, the user can access the document from the link destination server which has already been deleted from the document storing unit 32 as a link destination at the time when the new information history is seen.

Although the foregoing embodiment has been explained with respect to the example in which as an information collecting apparatus 10, it is applied to, for example, the personal computer having the hardware resource as shown in FIG. 2, it can be applied as it is to other apparatuses such as personal assistance and proper computer apparatus. The invention incorporates proper modifications without departing from the object and advantages of the invention. Further, the invention is not limited by the numerical values shown in the foregoing embodiments.

As described above, according to the invention, the specific site is monitored as an event collecting destination site and when the event occurrence due to the update of the site information is detected, the keyword to specify the event such as announcement of the new product, incidence of a new virus, or the like is extracted from its updated contents, and the information is searched from the information collecting destination site by using the extracted keyword and displayed to the user. Thus, the user does not need to set a word for specifying the information such as a keyword or the like. Even in the case of information which are unknown to the user, it is possible to automatically collect the valid information from a plurality of information providing destinations and notify the user of it.

Particularly, with respect to the new product information, new virus incidence information, or the like which needs to be promptly collected, merely by preliminarily registering the event collecting destination sites, the user can be notified of the event occurrence such as new product announcement or new virus incidence. The user can be notified of the information such as contents, reputation, price, and the like of the new product and the information of a countermeasure against a virus by a personal computer manufacturer with regard to the incidence of a new virus. For a dynamic event occurring on the network, necessary information can be promptly and properly collected and provided to the user.

What is claimed is:

1. An information collecting apparatus comprising:
a network connecting unit which connects to a network;
an event collecting destination site registering unit which registers event collecting destination sites for detecting the presence or absence of an event which occurred on the network or in the real world;
an information collecting destination site registering unit which registers information collecting destination sites for collecting documents including data such as text, image, audio sound, and the like;
an event detecting unit which obtains information from said registered event collecting destination sites and detects the presence or absence of the occurrence of the event from the presence or absence of an update of the obtained information;
a keyword extracting unit which extracts one or more keywords from an updating area detected by said event detecting unit;
an information searching unit which searches the documents in said registered information collecting destination sites by using the keyword extracted by said keyword extracting unit; and
an information notifying unit which notifies the user of a search result of said information searching unit.

2. An apparatus according to claim 1, wherein said event detecting unit accesses said event collecting destination site, downloads the document in said site, stores it as a reference, thereafter, detects the presence or absence of the event occurrence from the presence or absence of the update by comparing the document downloaded from said event collecting destination site with said reference, and updates said reference by using said downloaded document.

3. An apparatus according to claim 1, wherein said information searching unit accesses said information collecting destination site, downloads the document in said site, and searches a corresponding document portion by using said keyword from the downloaded document.

4. An apparatus according to claim 1, further comprising a document storing unit which stores the document obtained from said information collecting destination site by said information searching unit.

5. An apparatus according to claim 1, wherein said information searching unit periodically searches the documents in said registered information collecting destination sites for a predetermined period of time by using the keyword extracted by said keyword extracting unit.

6. An apparatus according to claim 1, wherein
said event collecting destination site registering unit obtains the event collecting destination site from an event collecting destination list server via the network and registers it, and
said information collecting destination site registering unit obtains the information collecting destination site from an information collecting destination list server via the network and registers it.

7. An apparatus according to claim 1, wherein
said event collecting destination site registering unit obtains event collecting destination sites from another information collecting apparatus having the same construction via the network and registers them, and
said information collecting destination site registering unit obtains information collecting destination sites from the information collecting apparatus having the same construction via the network and registers them.

8. An apparatus according to claim 1, wherein said keyword extracting unit morpheme-analyzes the updating area detected by said event detecting unit, divides it every part of speech, thereafter, extracts only proper nouns, and if the extracted nouns are different from existing keywords registered in a keyword database, outputs the extracted proper nouns as keywords to said information searching unit.

9. An apparatus according to claim 1, wherein if only new information has been added to the updating area of the event collecting destination site in which the event occurrence has been detected, said event detecting unit stores a history of said new information, and if old information was deleted simultaneously with the addition of the new information to said updating area, said event detecting unit stores the history of said new information and a history of said deleted information and said information notifying unit is enabled to notify the user of the stored histories.

10. An apparatus according to claim 1, wherein if only new information has been added to the updating area of the event collecting destination site in which the event occurrence has been detected, said event detecting unit stores the keyword extracted by said keyword extracting unit as a history of said new information, and if old information was deleted simultaneously with the addition of the new information to said updating area, said event detecting unit stores the keyword extracted by said keyword extracting unit as a history of said new information and a history of said deleted information and said information notifying unit is enabled to notify the user of said keyword as stored histories.

11. An information collecting method comprising:
an event collecting destination site registering step wherein event collecting destination sites for detecting the presence or absence of an event occurring on a network or in the real world are registered by an event collecting destination site registering unit;
an information collecting destination site registering step wherein information collecting destination sites for collecting documents including data such as text, image, audio sound, and the like are registered by an information collecting destination site registering unit;
an event detecting step wherein information is obtained from said registered event collecting destination sites and the presence or absence of event occurrence is detected by an event detecting unit on the basis of the presence or absence of update of the obtained information;
a keyword extracting step wherein one or more keywords are extracted by a keyword extracting unit from an updating area detected in said event detecting step;
an information searching step wherein the documents in said registered information collecting destination sites are searched by an information searching unit by using the keyword extracted in said keyword extracting step; and
an information notifying step wherein the user is notified of a search result of said information searching step by an information notifying unit.

12. A method according to claim 11, wherein in said event detecting step, said event collecting destination site is accessed, the document in said site is downloaded and stored as a reference, and thereafter, the presence or absence of the event occurrence is detected from the presence or absence of the update by comparing the document downloaded from said event collecting destination site with said reference.

13. A method according to claim 11, wherein in said information searching step, said information collecting destination site is accessed, the document in said site is downloaded, and a corresponding document portion is searched by using said keyword from the downloaded document.

14. A method according to claim 11, further comprising a document storing step wherein the document obtained from said information collecting destination site by said information searching step is stored into a document storing unit.

15. A method according to claim 11, wherein in said information searching step, the number of searching times of the document search using said keyword is counted, if the number of searching times of the document after the elapse of a predetermined time exceeds a predetermined threshold value, the information search of the document by said keyword is again continued for a predetermined period of time, and if the number of searching times is equal to or less than said threshold value, the information search of the document by said keyword is stopped.

16. A method according to claim 11, wherein
in said event collecting destination site registering step, the event collecting destination site is obtained from an event collecting destination list server via the network and registered, and
in said information collecting destination site registering step, the information collecting destination site is obtained from an information collecting destination list server via the network and registered.

17. A method according to claim 11, wherein
in said event collecting destination site registering step, event collecting destination sites are obtained from another information collecting apparatus having the same construction via the network and registered, and
in said information collecting destination site registering step, information collecting destination sites are obtained from the information collecting apparatus having the same construction via the network and registered.

18. A method according to claim 11, wherein in said keyword extracting step, the updating area detected in said event detecting step is morpheme-analyzed and divided every part of speech, thereafter, only proper nouns are extracted, and if the extracted nouns are different from existing keywords registered in a keyword database, the extracted proper nouns are outputted as keywords to said information searching step.

19. A method according to claim 11, wherein in said event detecting step, if only new information has been added to the updating area of the event collecting destination site in which the event occurrence has been detected, a history of said new information is stored, and if old information was deleted simultaneously with the addition of the new information to said updating area, the history of said new information and a history of said deleted information are stored and said information notifying unit is enabled to notify the user of the stored histories.

20. A method according to claim 11, wherein in said event detecting step, if only new information has been added to the updating area of the event collecting destination site in which the event occurrence has been detected, the keyword extracted in said keyword extracting step is stored as a history of said new information, and if old information was deleted simultaneously with the addition of the new information to said updating area, the keyword extracted by said keyword extracting unit is stored as a history of said new information and a history of said deleted information and said information notifying unit is enabled to notify the user of said keyword as stored histories.

21. A program for allowing a computer to execute:
an event collecting destination site registering step wherein event collecting destination sites for detecting the presence or absence of an event occurring on a network or in the real world are registered;
an information collecting destination site registering step wherein information collecting destination sites for collecting documents including data such as text, image, audio sound, and the like are registered;
an event detecting step wherein information is obtained from said registered event collecting destination sites and the presence or absence of event occurrence is detected on the basis of the presence or absence of update of the obtained information;
a keyword extracting step wherein one or more keywords are extracted from an updating area detected in said event detecting step;
an information searching step wherein the documents in said registered information collecting destination sites are searched by using the keyword extracted in said keyword extracting step; and
an information notifying step wherein the user is notified of a search result of said information searching step.

22. A program according to claim 21, wherein said event detecting step, said event collecting destination site is accessed, the document in said site is downloaded and stored as a reference, and thereafter, the presence or absence of the event occurrence is detected from the presence or absence of the update by comparing the document downloaded from said event collecting destination site with said reference.

23. A program according to claim 21, wherein in said information searching step, said information collecting destination site is accessed, the document in said site is downloaded, and a corresponding document portion is searched by using said keyword from the downloaded document.

24. A program according to claim 21, further comprising a document storing step wherein the document obtained from said information collecting destination site by said information searching step is stored into a document storing unit.

25. A program according to claim 21, wherein in said information searching step, the documents in said registered information collecting destination sites are periodically searched for a predetermined period of time by using the keyword extracted in said keyword extracting step.

26. A program according to claim 21, wherein
in said event collecting destination site registering step, the event collecting destination site is obtained from an event collecting destination list server via the network and registered, and
in said information collecting destination site registering step, the information collecting destination site is obtained from an information collecting destination list server via the network and registered.

27. A program according to claim 21, wherein
in said event collecting destination site registering step, event collecting destination sites are obtained from another information collecting apparatus having the same construction via the network and registered, and
in said information collecting destination site registering step, information collecting destination sites are obtained from the information collecting apparatus having the same construction via the network and registered.

28. A program according to claim 21, wherein in said keyword extracting step, the updating area detected in said event detecting step is morpheme-analyzed and divided every part of speech, thereafter, only proper nouns are extracted, and if the extracted nouns are different from existing keywords registered in a keyword database, the extracted proper nouns are outputted as keywords to said information searching step.

29. A program according to claim 21, wherein in said event detecting step, if only new information has been added to the updating area of the event collecting destination site in which the event occurrence has been detected, a history of said new information is stored, and if old information was deleted simultaneously with the addition of the new information to said updating area, the history of said new information and a history of said deleted information are stored and said information notifying unit is enabled to notify the user of the stored histories.

30. A program according to claim 21, wherein in said event detecting step, if only new information has been added to the updating area of the event collecting destination site in which the event occurrence has been detected, the keyword extracted in said keyword extracting step is stored as a history of said new information, and if old information was deleted simultaneously with the addition of the new information to said updating area, the keyword extracted in said keyword extracting step is stored as a history of said new information and a history of said deleted information and said information notifying unit is enabled to notify the user of said keyword as stored histories.
